(19) United States
(12) Patent Application Publication
(10) Pub. No.: US 2023/0327723 A1
(43) Pub. Date: Oct. 12, 2023

(54) SYNCHRONIZATION SIGNAL BLOCK SCHEME AND ACQUISITION

(71) Applicant: INTERDIGITAL PATENT HOLDINGS, INC., Wilmington, DE (US)

(72) Inventors: Kyle PAN, Saint James, NY (US); Patrick SVEDMAN, Stockholm (SE); Guodong ZHANG, Woodbury, NY (US); Mohamed M. AWADIN, Plymouth Meeting, PA (US); Pascal ADJAKPLE, Great Neck, NY (US); Yifan LI, Conshohocken, PA (US); Allan TSAI, Boonton, NJ (US); Zhuo CHEN, Claymont, DE (US)

(21) Appl. No.: 17/998,526

(22) PCT Filed: May 14, 2021
(86) PCT No.: PCT/US2021/032380

§ 371 Date: Nov. 11, 2022

Related U.S. Application Data
(60) Provisional application No. 63/024,768, filed on May 14, 2020.

(51) Int. Cl. H04B 7/06; H04W 56/00

(52) U.S. Cl. CPC H04B 7/0617; H04W 56/0015

(57) ABSTRACT

Synchronization Signal Block (SSB) management for new radio may be achieved through indication of a maximum number of beams for beamforming and/or through mechanisms for handling plural candidate SSBs. For example, a User Equipment (UE) may search a Primary Synchronization Signal (PSS) and/or a Secondary Synchronization Signal (SSS) to decode a Physical Broadcast Channel (PBCH) payload comprising and indication of a maximum number of beams (Q) supporting beamforming, e.g., in new radio unlicensed spectrum, and determine, based the indicator, Quasi Co-Located (QCL) Synchronization Signal Blocks (SSBs). Similarly, a UE may determine, from the PBCH payload, a primary DeModulation Reference Signal (DMRS) from which the UE may determine selection bits for an SSB. The UE may also determine, based a frequency range in use, to perform a secondary detection and based on the secondary detection, alter selection bits for accessing the SSB index.

### CROSS-REFERENCE TO RELATED APPLICATIONS

This application claims the benefit of U.S. Provisional Patent Application No. 63/024,768, filed May 14, 2020, which is hereby incorporated by reference in its entirety.

### BACKGROUND

This disclosure pertains to the management of beams and synchronization signals in wireless network such as, but not limited to, those described in: 3GPP TR 38.913 Study on Scenarios and Requirements for Next Generation Access Technologies; (Release 14), V14.3.0; 3GPP TS 38.306 User Equipment (UE) radio access capabilities; (Release 15), V15.3.0; 3GPP TS 38.101-1 User Equipment (UE) radio transmission and reception; Part 1: Range 1 Standalone (Release-16), V16.2.0; 3GPP TS 38.101-2 User Equipment (UE) radio transmission and reception; Part 2: Range 2 Standalone (Release-16), V16.2.0.

### SUMMARY

Synchronization Signal Block (SSB) schemes and acquisition may be achieved in a number of ways. A first set of solutions involve mechanisms of determining, signalling, and/or acquiring the maximum number of beams. Herein, the maximum number of beams is denoted Q. Q mechanisms may support different numbers, ranges, and granularity of Q, e.g., for beamforming in NR unlicensed spectrum up to 71 GHz. Indication schemes as well as acquisition procedures for Q are described herein, as are Q acquisition methods for different frequency ranges.

For example, coarse granularity for beamforming may be used covering the entire range up to a maximum 64 beams, or finer granularity may be used covering a certain range. Higher granularity may be supported at the cost of higher signalling overhead. For example, multiple configuration tables with different granularity levels may be used. Depending on the channel condition or CBR or the like, one of the configuration table may be used, and may be indicated explicitly or implicitly. Q tables may be predefined, specified, configured, or pre-configured, and the value of Q may be indicated to a User Equipment (UE) accordingly.

Q may be indicated in a variety of ways. For example, Q may be indicated using a pointer to RMSI.

Multiple Q configuration tables may be used. The tables may be of equal sizes but refer different granularities of Q for use in different ranges. Alternatively, tables of different sizes may be used, e.g., for the same for different granularities for the same frequency range, or for varying frequency ranges.

Tables may be signaled in a variety of ways. Tables may be pre-defined, for example, and table indices may be signaled to UEs. Different tables may be signaled differently. For example, a small Q table may be indicated in PBCH and a larger Q table may be indicated in RMSI. Q may be indicated via either a PDCCH or a PDSCH of RMSI.

A Q override indicator may be provided in RMSI, e.g., in PDCCH/DCI or PDSCH, which indicates to a UE to override, e.g., the use of a first table with the use of another table, or with an updated Q value.

Q may be indicated using split bits. For example, example, bits for Q may be split into PBCH and RMSI. Alternatively, bits for Q may be carried in RMSI and split between DCI/PDCCH and PDSCH of RMSI.

A second set of solutions involve the mechanisms for acquiring and handling candidate SSBs. For example, candidate SSB indexing may be used for beamforming for NR unlicensed spectrum, e.g., for up to 71 GHz. Mechanisms for candidate SSBs to overcome or mitigate channel uncertainty and LBT failure are described herein, as are methods of candidate SSB indexing for different frequency ranges. The associated indication schemes as well as acquisition procedures for candidate SSB indices are also described.

The indication of candidate SSB positions or position indexes may be achieved in a number of ways. For example, explicit, implicit, or a combination of implicit and explicit indication of candidate SSB positions may be used.

Primary DMRS and secondary DMRS may be used, e.g., whereby primary DMRS is inside SSB and secondary DMRS may be either inside or outside SS/PBCH block, for example.

A supplemental SSB index signal may be used to extend candidate SSB positions. Supplemental SSB index signaling may be sequence-based, and a UE's detection of the supplemental SSB index may employ a correlation-based detection or the like, for example.

Alternatively, supplemental SSB index signaling may be payload-based, and channel decoding may be employed at the UE to detect it.

CSI-RS may be used for candidate SSB position indication. CSI-RS may be in some predefined or configured positions in time/frequency with respect to SSB. CSI-RS may be multiplexed with SSB, e.g., TDM or FDM or combination of both. CSI-RS may be attached to SSB or embedded in SSB.

Explicit indication e.g., via subcarrier indication bits, pdcch-ConfigSIB1 bits, and/or spare bits in MIB, may be used for candidate SSB positions indication.

Solutions may include extending SSB to x OFDM symbols, e.g., where x>4. Similarly, SSB sequence space may be extended for PSS and/or SSS.

Hybrid implicit and explicit indication may be used. Extended SSB indication may use joint supplemental SSB index signal indication and/or joint implicit and explicit indication.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings.

FIG. 1 is a time and frequency diagram of an example structure of SSB. Time is given in the X-axis by OFDM symbol, and frequency in Y-axis by subcarrier number.

FIG. 2 is a flowchart of UE behavior for a first Q scheme.

FIG. 3 is a flowchart of UE behavior for a second Q scheme.

FIG. 4 is a flowchart of UE behavior for a third Q scheme.

FIG. 5 is a flowchart of UE behavior for a fourth Q scheme.

FIG. 6 illustrates an example P-DMRS/S-DMRS structure.

FIG. 7 is a flowchart of an example procedures for P-DMRS/S-DMRS.

FIG. 8 illustrates an example E-DMRS SSB structure.

FIG. 9 illustrates an example piggyback DMRS SSB scheme.

FIG. 10 illustrates an example a first example J-CSI-RS/DMRS SSB structure.

FIG. 11 illustrates an example a second J-CSI-RS/DMRS SSB structure.

FIG. 12 is a flowchart of an example procedures for CSI-RS/DMRS.

FIG. 13 is a flowchart of an example procedure for a supplemental SSB index signal.

FIG. 14 illustrates an example Group SSB (G-SSB) indication scheme with a second PBCH.

FIG. 15 illustrates an example Group SSB (G-SSB) indication scheme with repeated PBCH.

FIG. 16 illustrates an example Group-based SSB (G-SSB) indication.

FIG. 17 illustrates an example Extended SSB (E-SSB) indication scheme.

FIG. 18A illustrates an example communications system in which the methods and apparatuses described and claimed herein may be embodied.

FIG. 18B is a block diagram of an example apparatus or device configured for wireless communications.

FIG. 18C is a system diagram of an example radio access network (RAN) and core network.

FIG. 18D is a system diagram of another example RAN and core network.

FIG. 18E is a system diagram of another example RAN and core network.

FIG. 18F is a block diagram of an example computing system.

FIG. 18G is a block diagram of another example communications system.

### DETAILED DESCRIPTION

Table 20 of the Appendix contains many of the abbreviations used herein.

The term “procedure” herein generally refers to techniques for performing operations to achieve particular ends. The steps described herein for procedures are often optional and may potentially be performed in a variety of ways and a variety of sequences. Hence, herein the term “procedure” should not be interpreted as referring to a rigid set and sequence of steps, but rather to a general methodology for achieving results that may be adapted in a variety of ways.

### NR Study Item

In order to support wide range of services, 5G NR system aims to be flexible enough to meet the connectivity requirements of a range of existing and future (as yet unknown) services to be deployable in an efficient manner. In particular, NR considers supporting potential use of frequency range up to 100 GHz. See TR 38.913.

NR specifications that have been developed in Rel-15 and Rel-16 define operation for frequencies up to 52.6 GHz, where all physical layer channels, signals, procedures, and protocols are designed to be optimized for uses under 52.6 GHz.

However, frequencies above 52.6 GHz are faced with more difficult challenges, such as higher phase noise, larger propagation loss due to high atmospheric absorption, lower power amplifier efficiency, and strong power spectral density regulatory requirements in unlicensed bands, compared to lower frequency bands. Additionally, the frequency ranges above 52.6 GHz potentially contain larger spectrum allocations and larger bandwidths that are not available for bands lower than 52.6 GHz.

As an initial effort to enable and optimize 3GPP NR system for operation in above 52.6 GHz, 3GPP RAN has studied requirements for NR beyond 52.6 GHz up to 114.25 GHz including global spectrum availability and regulatory requirements (including channelization and licensing regimes), potential use cases and deployment scenarios, and NR system design requirements and considerations on top of regulatory requirements. See TR 38.807. The potential use cases identified in the study include high data rate eMBB, mobile data offloading, short range high-data rate D2D communications, broadband distribution networks, integrated access backhaul (IAB), factory automation, industrial IoT (IIoT), wireless display transfer, augmented reality (AR)/virtual reality (VR) wearables, intelligent transport systems (ITS) and V2X, data center inter-rack connectivity, smart grid automation, private networks, and support of high positioning accuracy. The use cases span over several deployment scenarios identified in the study. The deployment scenarios include, but not limited to, indoor hotspot, dense urban, urban micro, urban macro, rural, factor hall, and indoor D2D scenarios. The study also identified several system design requirements around waveform, MIMO operation, device power consumption, channelization, bandwidth, range, availability, connectivity, spectrum regime considerations, and others.

Among the frequencies of interest, frequencies between 52.6 GHz and 71 GHz are especially interesting relatively in the short term because of their proximity to sub-52.6 GHz for which the current NR system is optimized and the imminent commercial opportunities for high data rate communications, e.g., unlicensed spectrum but also licensed spectrum between 57 GHz and 71 GHz. Therefore, it would be beneficial to make a study focused on feasibility of using existing waveforms and required changes for frequencies between 52.6 GHz and 71 GHz, so as to take advantage of imminent commercial opportunities for the specific frequency regime by minimizing the specification burden and maximizing the leverage of FR2 based implementations.

Objectives of the study include study of required changes to NR using existing DL/UL NR waveform to support operation between 52.6 GHz and 71 GHz, such as applicable numerology including subcarrier spacing, channel BW (including maximum BW), and their impact to FR2 physical layer design to support system functionality considering practical RF impairments [RAN1, RAN4], toward identify potential critical problems to physical signal/channels, if any [RAN1].

Objectives further include study of channel access mechanism, considering potential interference to/from other nodes, assuming beam-based operation, in order to comply with the regulatory requirements applicable to unlicensed spectrum for frequencies between 52.6 GHz and 71 GHz [RAN1]. Any potential interference impact, if identified, may require interference mitigation solutions as part of a channel access mechanism.

### Work Item

NR Rel-15 defined two frequency ranges for operation, with a first frequency range (FR1) spanning from 410 MHz to 7.125 GHz, and a second (FR2) spanning from 24.25GHz to 52.6 GHz.

RAN carried out a Rel-16 study on NR beyond 52.6 GHz (FS_NR_beyond_52 GHz) with corresponding TR in 38.807. From this study, it became apparent the global availability of bands in the 52.6 GHz to 71 GHz range, most notably in the form of the original 60 GHz band (57-66 GHz) and extended 60 GHz band (57-71 GHz). Moreover, WRC19 recently identified the 66-71 GHz frequency range for IMT operation in certain regions.

The proximity of this frequency range (57-71 GHz) to FR2 and the imminent commercial opportunities for high data rate communications makes it attractive to adapt 3GPP approaches to address NR operation in this frequency regime.

In order to minimize the specification burden and maximize the leverage of FR2 based implementations, 3GPP has decided to extend FR2 operation up to 71 GHz with the adoption of one or more new numerologies (e.g., larger subcarrier spacings). That or those new numerologies will be identified by the study on waveform for NR>52.6GHz in the first half of 2020. NR-U defined procedures for operation in unlicensed spectrum will also be leveraged towards operation in the unlicensed 60 GHz band.

According to the outcome of the study item on Supporting NR above 52.6 GHz and leveraging FR2 design to the extent possible, this WI extends NR operation up to 71 GHz considering, both, licensed and unlicensed operation, with the following four objectives.

First are the physical layer aspects including [RAN1] numerology, timing, and SSB beams. For new numerology or numerologies (μ value in 38.211) for operation in this frequency range, this includes addressing impact on physical signals/channels if any, as identified in the SI. Timeline related aspects are adapted to each of the new numerologies, e.g., BWP and beam switching times, HARQ scheduling, UE processing, preparation, and computation times for PDSCH, PUSCH/SRS and CSI, respectively. Support of up to 64 SSB beams for licensed and unlicensed operation in this frequency range is an objective.

Second are physical layer procedures [RAN1], including a channel access mechanism assuming beam-based operation in order to comply with the regulatory requirements applicable to unlicensed spectrum for frequencies between 52.6 GHz and 71 GHz.

Third are radio interface protocol architecture and procedures [RAN2] for or operation in unlicensed spectrum in this frequency range. Protocol aspects, as required, may be adjusted to specify the channel access mechanism for unlicensed operation in this frequency range.

Fourth are core specifications for UE, gNB and RRM requirements [RAN4], which would specify new band(s) for the frequency range from 52.6 GHz-71 GHz. The band(s) definition should include UL/DL operation and exclude ITS spectrum in this frequency range. This would also specify gNB and UE RF core requirements for the band(s) in the above frequency range, including a limited set of example band combinations The WI can be completed provided requirements for at least one band combination involving a new NR-U band is specified as long as it is in line with country-specific regulatory directives. The core specifications would include RRM/RLM core requirements.

Similar to regular NR and NR-U operations below 52.6 GHz, NR/NR-U operation in the 52.6 GHz to 71 GHz can be in stand-alone or aggregated via CA or DC with an anchor carrier.

### NR-U

In Release-16 New Radio Unlicensed (NR-U), The supported numerology (e.g., SCS) can be set as 15, 30 and 60 KHz. respectively. The listen-before-talk (LBT) bandwidth is set to 20 MHz in Release-16 NR-U. Based on the minimum LBT bandwidth must be supported, the DL initial BWP is nominally 20 MHz for Rel-16 NR-U. The maximum supported channel bandwidth is set to 100 MHz. The UE channel bandwidth (or an activated BWP) can be set as an integer multiple of LBT bandwidth (e.g., 20 MHz). For instance, for SCS=30 KHz, the total allocated PRB numbers for 20 MHz, 40 MHz and 80 MHz bandwidth is equal to 48, 102, and 214, respectively.

In Release-16 NR-U, the PRBs allocated by frequencyDomainResources in the CORESET configuration are confined within one of LBT bandwidths within the BWP corresponding to the CORESET. In this way, a PDCCH is confined within an LBT bandwidth in order to avoid partial puncturing of a DCI. A UE can stop monitoring PDCCH searching spaces on LBT bandwidth not available after acquiring the knowledge of transmitted LBT bandwidth(s) from GC-PDCCH. Within the search space set configuration associated with the CORESET, each of the one or more monitoring locations in the frequency domain corresponds to (and is confined within) an LBT bandwidth and has a frequency domain resource allocation pattern that is replicated from the pattern configured in the CORESET. In this way, CORESET parameters other than frequency domain resource allocation pattern is identical for each of the one or more monitoring locations in the frequency domain.

### NR/NR-U Cell Search

Cell search is the procedure for a UE to acquire time and frequency synchronization with a cell and to detect the physical layer Cell ID of the cell.

A UE receives the following synchronization signals (SS) in order to perform cell search using the primary synchronization signal (PSS) and secondary synchronization signal (SSS).

A UE assumes that reception occasions of a physical broadcast channel (PBCH), PSS, and SSS are in consecutive symbols and form a SS/PBCH block. The UE assumes that SSS, PBCH DM-RS, and PBCH data have same EPRE. The UE may assume that the ratio of PSS EPRE to SSS EPRE in a SS/PBCH block is either 0 dB or 3 dB. If the UE has not been provided dedicated higher layer parameters, the UE may assume that the ratio of PDCCH DMRS EPRE to SSS EPRE is within −8 dB and 8 dB when the UE monitors PDCCHs for a DCI format 1_0 with CRC scrambled by SI-RNTI, P-RNTI, or RA-RNTI.

For a half frame with SS/PBCH blocks, the first symbol indexes for candidate SS/PBCH blocks are determined according to the SCS of SS/PBCH blocks as follows, where index 0 corresponds to the first symbol of the first slot in a half-frame.

The candidate SS/PBCH blocks in a half frame are indexed in an ascending order in time from 0 to L̅ₘₐₓ−1, where for operation without shared spectrum channel access, L̅ₘₐₓ=Lₘₐₓ, and Lₘₐₓ is as described in TS 38.104. For operation with shared spectrum channel access, L̅ₘₐₓ=10 for 15 kHz SCS of SS/PBCH blocks, and L̅ₘₐₓ=20 for 30 kHz SCS of SS/PBCH blocks.

For L̅ₘₐₓ=4, a UE determines the 2 LSB bits of a candidate SS/PBCH block index per half frame from a one-to-one mapping with an index of the DM-RS sequence transmitted in the PBCH.

For L̅ₘₐₓ>4, a UE determines the 3 LSB bits of a candidate SS/PBCH block index per half frame from a one-to-one mapping with an index of the DM-RS sequence transmitted in the PBCH.

For L̅ₘₐₓ=10, the UE determines the 1 MSB bit of the candidate SS/PBCH block index from PBCH payload bit α̅ _{Ā+7}.

For L̅ₘₐₓ=20, the UE determines the 2 MSB bits of the candidate SS/PBCH block index from PBCH payload bits α̅ _{Ā+6}, α̅ _{Ā+7}.

For L̅ₘₐₓ=64, the UE determines the 3 MSB bits of the candidate SS/PBCH block index from PBCH payload bits α̅ _{Ā+5}, α̅ _{Ā+6}, α_{A+7}.

A UE can be provided per serving cell by ssb-periodicayServingCell a periodicity of the half frames for reception of the SS/PBCH blocks for the serving cell. If the UE is not configured a periodicity of the half frames for receptions of the SS/PBCH blocks, the UE assumes a periodicity of a half frame. A UE assumes that the periodicity is same for all SS/PBCH blocks in the serving cell.

For initial cell selection, a UE may assume that half frames with SS/PBCH blocks occur with a periodicity of 2 frames.

For operation without shared spectrum channel access, an SS/PBCH block index is same as a candidate SS/PBCH block index.

For operation with shared spectrum channel access, a UE assumes that transmission of SS/PBCH blocks in a half frame is within a discovery burst transmission window that starts from the first symbol of the first slot in a half-frame. The UE can be provided per serving cell by DiscoveryBurst-WindowLength-r16 a duration of the discovery burst transmission window. If DiscoveryBurst-WindowLength-r16 is not provided, the UE assumes that the duration of the discovery burst transmission window is a half frame. For a serving cell, the UE assumes that a periodicity of the discovery burst transmission window is same as a periodicity of half frames for receptions of SS/PBCH blocks in the serving cell. The UE assumes that one or more SS/PBCH blocks indicated by ssb-PositionslnBurst may be transmitted within the discovery burst transmission window and have candidate SS/PBCH blocks indexes corresponding to SS/PBCH block indexes provided by ssb-PositionsInBurst. If MSB k, k≥1, of ssb-PositionsInBurst is set to 1, the UE assumes that one or more SS/PBCH blocks within the discovery burst transmission window with candidate SS/PBCH block indexes corresponding to SS/PBCH block index equal to k−1 may be transmitted; if MSB k is set to 0, the UE assumes that the SS/PBCH block(s) are not transmitted.

For operation with shared spectrum channel access, a UE assumes that SS/PBCH blocks in a serving cell that are within a same discovery burst transmission window or across discovery burst transmission windows are quasi co-located with respect to average gain, QCL-TypeA, and QCL-TypeD properties, when applicable, if a value of (N_{DM-RS}^{PBCH} mod N_{SSB}^{QCL}) is same among the SS/PBCH blocks. N_{DM-RS}^{PBCH} is an index of a DM-RS sequence transmitted in a PBCH of a corresponding SS/PBCH block, and N_{SSB}^{QCL} is either provided by ssbPositionQCL-Relationship-r16 or, if ssbPositionQCL-Relationship-r16 is not provided, obtained from a MIB provided by a SS/PBCH block. ssbSubcarrierSpacingCommon indicates SCS of RMSI only for the case of “operation without shared spectrum”. The UE assumes that within a discovery burst transmission window, a number of transmitted SS/PBCH blocks on a serving cell is not larger than N_{SSB}^{QCL}. The UE can determine an SS/PBCH block index according to (N_{DM-RS}^{PBCH} mod N_{SSB}^{QCL}), or according to (ι̅ mod N_{SSB}^{QCL}) where ι̅ is the candidate SS/PBCH block index.

### Synchronization Signal and PBCH Block

The Synchronization Signal and PBCH block (SSB) consists of primary and secondary synchronization signals (PSS, SSS), each occupying 1 symbol and 127 subcarriers, and PBCH spanning across 3 OFDM symbols and 240 subcarriers, but on one symbol leaving an unused part in the middle for SSS. The possible time locations of SSBs within a half-frame are determined by sub-carrier spacing and the periodicity of the half-frames where SSBs are transmitted is configured by the network. During a half-frame, different SSBs may be transmitted in different spatial directions (e.g., using different beams, spanning the coverage area of a cell).

Within the frequency span of a carrier, multiple SSBs can be transmitted. The PCIs of SSBs transmitted in different frequency locations do not have to be unique, e.g., different SSBs in the frequency domain can have different PCIs. However, when an SSB is associated with an RMSI, the SSB corresponds to an individual cell, which has a unique NCGI. Such an SSB is referred to as a Cell-Defining SSB (CD-SSB). A PCell is always associated to a CD-SSB located on the synchronization raster. Polar coding is used for PBCH. The UE may assume a band-specific sub-carrier spacing for the SSB unless a network has configured the UE to assume a different sub-carrier spacing. PBCH symbols carry its own frequency-multiplexed DMRS. QPSK modulation is used for PBCH.

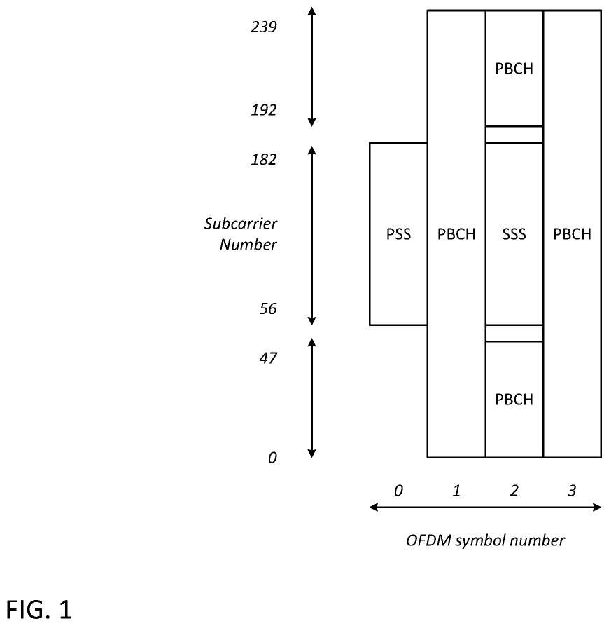

FIG. 1 illustrates an example time-frequency structure of SSB.

### Example Challenges

The maximum number of SSB beams for FR1 are 4 beams for frequency bands below 3 GHz and 8 beams for frequency beams between 3 GHz and 6 GHz. For operation in NR unlicensed or shared spectrum in FR1, the number of candidate SSBs is specified to 10 for 15 kHz SCS and 20 for 30 kHz SCS, in order to allows additional SSB transmission opportunities, with the objective to compensate for potential loss of transmission opportunities due to LBT failure or unavailability of the channel. For FR4 and FR2, NR-U operation has not been specified, and the current design of SSB transmission in licensed FR2 band assumes the number of candidates SSB is same as the number of SSB, with a maximum of 64 SSB beam. The existing SSB design whether in FR1 band or FR2 band are not readily reusable in the context of NR unlicensed or more broadly NR shared spectrum with deployment in frequency bands such as FR2 or FR4 which typically involves a larger number of SSB beams. As a result, there is a need to design SSB transmission for NR unlicensed or NR shared spectrum for use cases with up to 64 SSB beams.

Three cases of interest herein include SSB design issues in support of use cases including unlicensed spectrum use cases with support for up to 64 SSB beams. First is determination of maximum number of SSB beams for various frequency bands (e.g., FR2 or FR4) deployments and signaling to the UE of the maximum number of SSB beams. Second is indexing of candidate SSB (SS Block) positions and signaling to the UE of the maximum number of candidate SSB positions. Third is signaling to the UE, of the indexes of candidate SSB positions.

### Challenges for Support for up to 64 Beams

In NR unlicensed operation the UE assumes that within a discovery burst transmission window, a number of transmitted SS/PBCH blocks on a serving cell is not larger than N_{SSB}^{QCL}. This implies that the maximum number of beams can be supported is N_{SSB}^{QCL}. Currently only up to 8 beams can be supported.

To support maximum number of 64 beams, we need to have Qmax=64. In addition, to have better granularity and flexibility for beamforming, we should have more flexible values for N_{SSB}^{QCL}. Especially in higher frequency we may have much more beams with narrower beamwidth to overcome pathloss in high frequency range. Currently N_{SSB}^{QCL} may be 1, 2, 4 or 8. Q is equivalent to N_{SSB}^{QCL}. Qmax=max{Qi}. Q may employ more arbitrary number of beams. For example, N_{SSB}^{QCL}={1, 2, 3, 4, 5, 6, 7, 8, 9, . . . , 64}. The problem is that this will require high overhead.

How to design and efficiently indicate N_{SSB}^{QCL}? How to maintain the overhead while still achieve enough beamforming flexibility? How to design an Q indication scheme for FR4 (as well as FR2)? How to design an Q indication scheme such that it is unified across different frequency ranges e.g., FR4 and FR2 as well as FR1?

Efficient and a unified method for the determination of maximum number of SSB beams for various frequency bands (e.g., FR4 and FR2 as well as FR1) deployments and signalling to the UE of this value need to be developed.

Challenges for Support of More than 64 Candidate SSB Positions

Currently in Rel-15/16 NR-U operations, it can only support up to eight beams (e.g., Q=8). This may be sufficient for lower frequency range, e.g., FR1. However, for higher frequency ranges such as FR4 (up to 71 GH) and FR2 (up to 52.6 GHz), eight beams are generally not sufficient especially narrower beams for beamforming needs to be used for FR4 and FR2.

In order to support up to 64 beams for beamforming, we need to have more candidate SSB positions (larger than 64) in unlicensed spectrum for up to 71 GHz. Depending on how many SSB transmission opportunities we desire to have, different number of SSB candidate positions may be designed. More candidate SSB positions creates more transmission opportunities. However, it also creates higher signaling overhead for candidate SSB position indexing and indication.

With much larger number of candidate SSB positions, the current SSB indexing and indication mechanism cannot support it. Current SSB indexing and indication use DMRS and 3 bits in PBCH payload which can support 64 candidate SSB positions. In order to create more SSB transmission opportunities to overcome channel uncertainty and LBT failure, larger than 64 candidate SSB positions is needed and an efficient candidate SSB indication and indexing scheme supporting larger than 64 candidate SSB positions is required.

Efficient methods to index candidate SSB (SS Block) positions and signal to the UE the maximum number of candidate SSB positions for scenarios with up to 64 SSB beams need to be developed. Efficient methods to signal to the UE, indexes of candidate SSB positions for scenarios with up to 64 SSB beams need to be developed.

### Example Solutions

### Q Indication Mechanisms

In this section, mechanism and acquisition methods for configuration and indication of maximum number of beams to UE are described. Mechanism that supports different numbers and different ranges of beams as well as different granularity of beams for beamforming for NR unlicensed spectrum supporting up to 71 GHz are described and described. Maximum number of beams is denoted as Q. The associated indication schemes as well as acquisition procedures for Q are also described and described. Methods of Q mechanism and acquisition methods for different frequency ranges with unified approach are described. Detailed solutions are described.

Solutions for Q mechanism are described as follows: One solution is that a set of values for maximum number of beams for beamforming in FR4 may be defined. For example, a set of S values for Q may be defined and specified. For S=4, they may be Q0, Q1, Q2 and Q3 in a set. In order to support beamforming, values of Q0, Q1, Q2 and Q3 may be defined to create granularity for beamforming. For example, Q0, Q1, Q2 and Q3 may be set to 1, 8, 32, 64. This may create some coarse granularity for beamforming however it may cover the entire range up to maximum 64 beams for beamforming.

Alternatively, another solution is that other four values for maximum number of beams for Q0, Q1, Q2 and Q3 for beamforming in FR4 may be defined. In order to support finer beamforming, values of Q0, Q1, Q2 and Q3 may be set to 8, 16, 32 and 64 or 16, 32, 48 and 64. This may create some finer granularity for beamforming however it may not cover the entire range up to maximum 64 beams for beamforming. It could cover partial range up to maximum 64 beams for beamforming. Some flexibility for lower number of beams for beamforming may not be possible.

Yet another solution is that higher number of beams may be supported. Eight or higher values for maximum number of beams for Q0, Q1, Q2, Q3, Q4, Q5, Q6, and Q7 for beamforming in FR4 may be provided. Full or partial range for Q with fine or coarse granularity may be used.

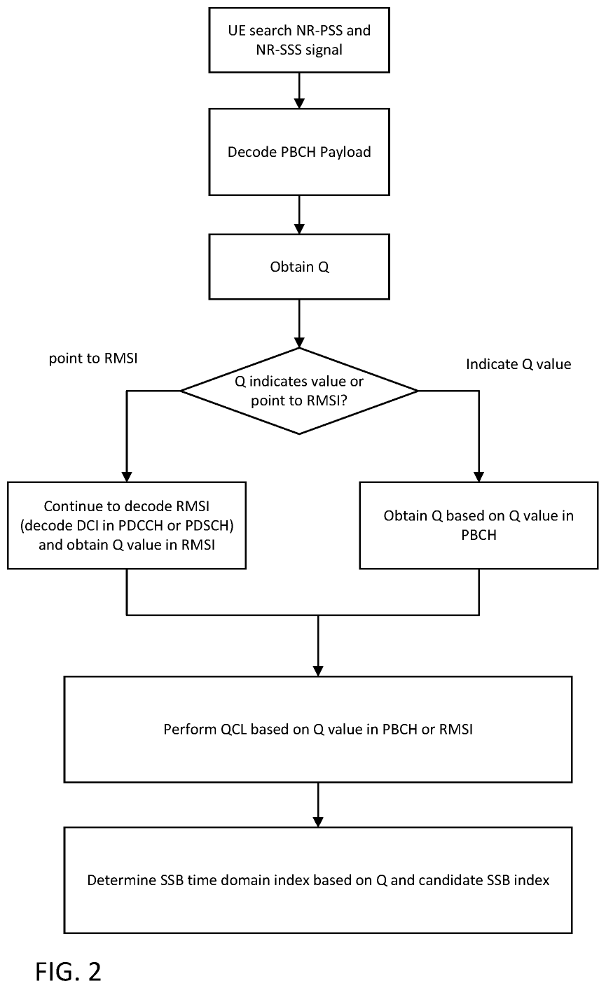

Solutions for Q indication scheme are described as follows. One solution may use indication of some Q values in PBCH with a flexibility of a pointer to RMSI for additional Q values. This solution for Q scheme is depicted in FIG. 2. As shown FIG. 2, UE may search NR-PSS and NR-SSS signal. UE may decode PBCH Payload and obtain the preliminary value of Q. UE may check the preliminary value of Q and see whether Q indicates one of the Q values or point to the RMSI.

If Q indicates one of the Q values in PBCH, then UE may obtain the maximum number of beams based on the Q value in PBCH. If the entry of Q indicates a pointer to the RMSI, then UE may continue to decode the RMSI for obtaining the value of Q. UE may decode PDCCH for DCI. UE may then decode PDSCH of RMSI and obtain Q value in RMSI PDSCH.

UE may decode downlink control information (DCI) carried in PDCCH for RMSI and obtain the value of Q if Q is indicated in DCI.

UE may make assumption on which SSBs are QCLed based on Q value obtained either in PBCH or RMSI. Once Q is obtained, UE may determine SSB index based on the obtained value of Q and the candidate SSB index. If UE knows Q, UE can determine QCLed SSBs within discovery reference signal (DRS) burst and across DRS bursts. The UE can determine an SS/PBCH block index according to (ι̅ mod N_{SSB}^{QCL}) where ι̅ is the candidate SS/PBCH block index.

Information element subCarrierSpacingCommon and Spare Bit in the MIB may be used to indicate value of Q and pointer. An example mapping between the combination of subCarrierSpacingCommon and Spare Bit to N_{SSB}^{QCL} is shown in Table 1 of the Appendix. In this case, the scs15 or 60 and spare bit as well as the scs30 or 120 and spare bit “0” indicate three Q values. The scs30 or 120 and spare bit “1” serves as a pointer that pointing to RMSI.

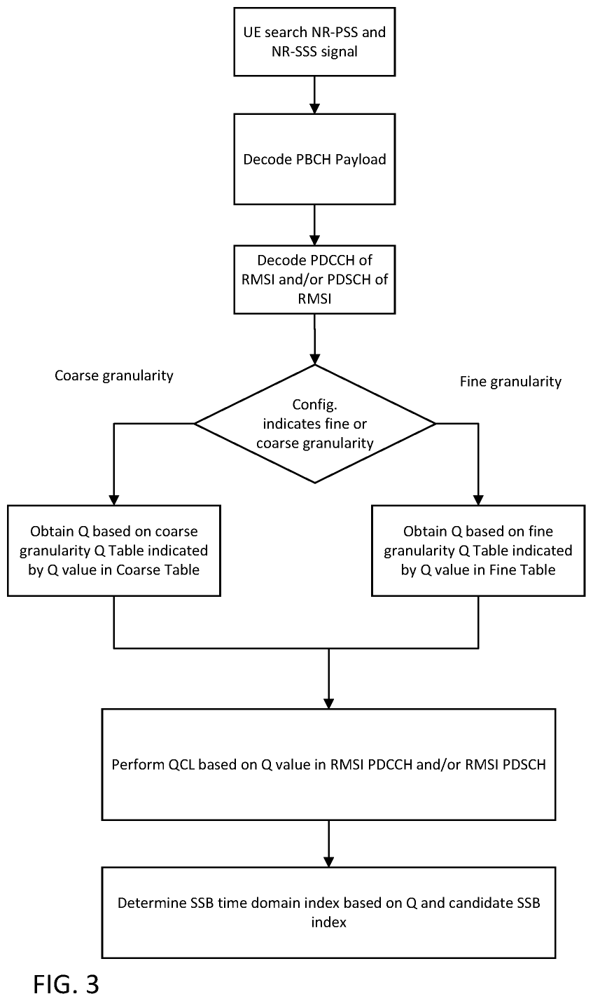

Another solution may use fine and coarse granularity for Q. Example for coarse granularity is shown in Table 2 of the Appendix. Example for fine granularity is shown in Table 3 of the Appendix. Such solution for Q scheme is depicted in FIG. 3. As shown in FIG. 3, UE may search NR-PSS and NR-SSS signals. UE may decode PBCH Payload (and obtain the Q if Q is indicated in PBCH).

UE may decode PDCCH of RMSI and PDSCH of RMSI. UE may check the configuration whether configuration or Config IE indicates fine or coarse granularity. If configuration or Config IE indicates fine granularity, then UE may obtain Q based on fine granularity Q table indicated by Q value in a fine granularity Table. Otherwise, then UE may obtain Q based on coarse granularity Q table indicated by Q value in a coarse granularity table.

Configuration for granularity may be pre-defined, specified in the standards or (pre)-configured. For example, FR4 may use fine granularity and FR2 may use coarse granularity. Alternatively, synchronization signal (SS) e.g., PSS/SSS may indicate or configure which granularity to use. For example, partitioning of SSS sequences may be used. One partition may be used to indicate one configuration or table and another partition may be used to indicate another configuration or table. If fine granularity is indicated or configured, then UE may use fine granularity table for Q. Otherwise, UE may use coarse granularity table for Q.

UE may perform QCL, that is, UE may make assumption on which SSBs are QCLed based on Q value obtained in PBCH or RMSI. Once Q is obtained, UE may determine SSB index based on Q and candidate SSB index. If UE knows Q, UE can determine QCLed SSBs within DRS burst and across DRS bursts. The UE can determine an SS/PBCH block index according to (ι̅ mod N_{SSB}^{QCL}) where ι̅ is the candidate SS/PBCH block index.

An example mapping between the combination of subCarrierSpacingCommon and Spare Bit to N_{SSB}^{QCL} for Coarse granularity is shown in Table 2. An example mapping between the combination of subCarrierSpacingCommon and Spare Bit to N_{SSB}^{QCL} for Finer granularity is shown in Table 3. In this case, the range for Q is from 16 to 64. Another example mapping between the combination of subCarrierSpacingCommon and Spare Bit to N_{SSB}^{QCL} for Finer granularity is shown in Table 4 of the Appendix. In this case, the range for Q is from 8 to 64.

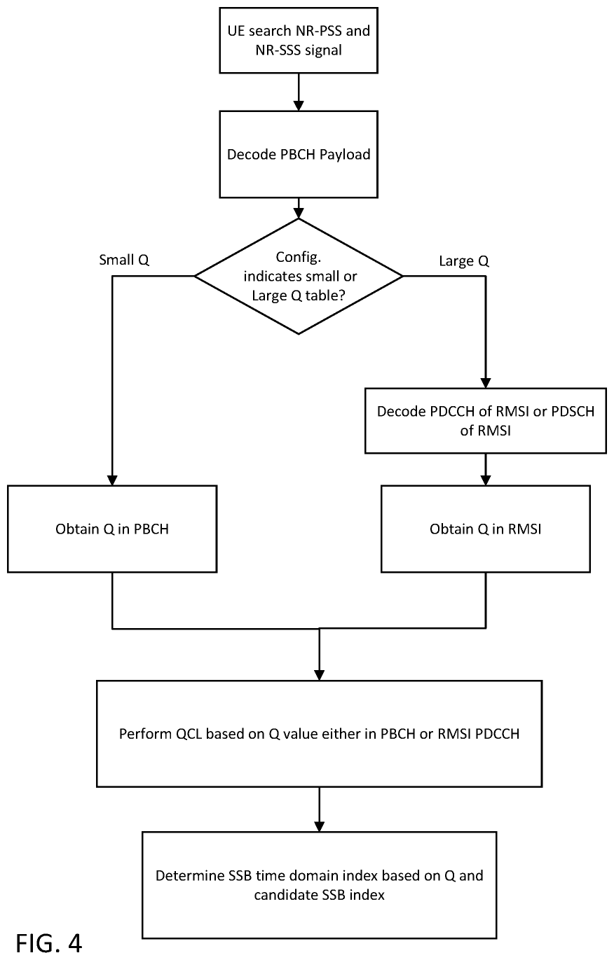

Another solution may use small or large tables for Q. This solution for Q scheme is depicted in FIG. 4. As shown in FIG. 4, UE may search NR-PSS and NR-SSS signal. UE may decode PBCH Payload.

UE may check the configuration whether Configuration or Config IE indicates small size or large size Q table. If Configuration or Config IE indicates small size Q table, UE may obtain the value of Q in PBCH. Otherwise, UE may continue to decode PDCCH of RMSI or PDSCH of RMSI. UE may obtain the value of Q in RMSI.

Configuration for granularity may be pre-defined or pre-configured. For example, FR4 may use large Q table and FR2 may use a small Q table. A Q table may also be configured. Alternatively, synchronization signal (SS) e.g., PSS/SSS may indicate or configure which size of table for Q to use. For example, partitioning of SSS sequences may be used. One partition may be used to indicate one configuration or size and another partition may be used to indicate another configuration or size. If small Q table is indicated or configured, then UE may use small table for Q. If large Q table is indicated or configured, then UE may use large table for Q.

UE may make assumption on which SSBs are QCLed based on Q value obtained in PBCH or RMSI. Once Q is obtained, UE may determine SSB index based on Q and candidate SSB index.

subCarrierSpacingCommon, Spare Bit and pdcch-ConfigSIB1 may be used to indicate the value of Q. For example, Bits such as MSB or LSB of pdcch-ConfigSIB1 may be used for indication purpose. An example mapping between the combination of subCarrierSpacingCommon, Spare Bit and pdcch-ConfigSIB1 to N_{SSB}^{NCL} is shown in Table 5 of the Appendix. MSB of pdcch-ConfigSIB1 may be used as an example. In this case, the scs15 or 60, scs30 or 120, spare bit as well as MSB of pdcch-ConfigSIB1 may indicate eight Q values in total.

Table 5 may be used as an example for large Q table. Table 2, Table 3 or Table 4 of the Appendix may be used as example for small Q table. Q table larger than 8 may also be considered and used. Q table smaller than 4 may also be considered and used.

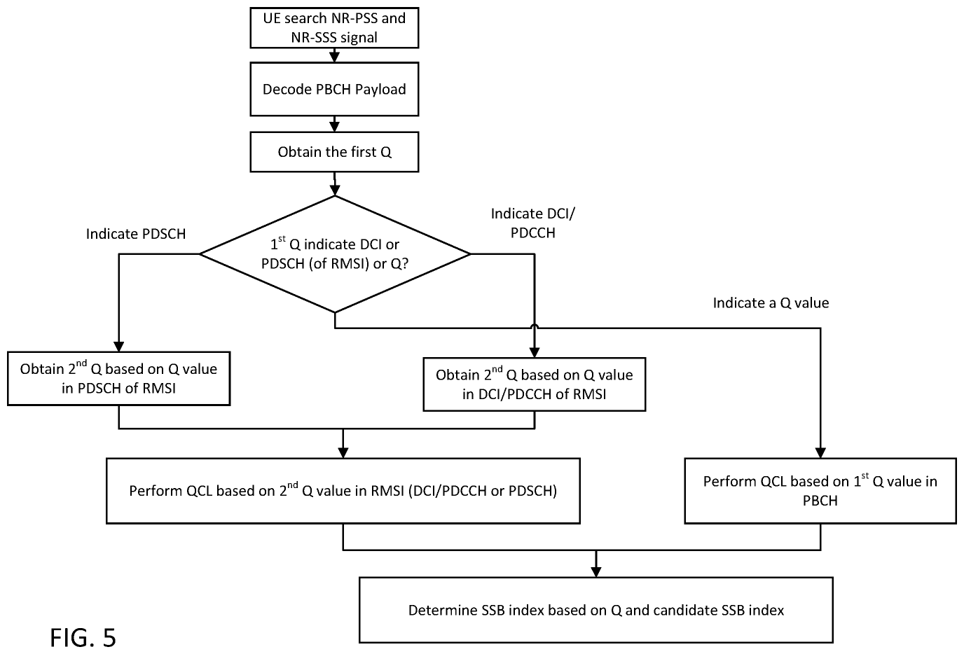

Yet another solution may use PDCCH or PDSCH to carry Q in RMSI. This solution for Q scheme is depicted in FIG. 5. As shown in FIG. 5. UE may search NR-PSS and NR-SSS signal. UE may decode PBCH Payload.

UE may obtain the first Q value. The first Q value may indicate whether additional Q is needed and where they are carried. If the first Q value indicates a true Q value, then UE may use this Q value for QCL assumption. If the first Q value indicates a pointer to RMSI PDCCH or RMSI PDSCH, then UE continue to decode RMSI to obtain the Q value. That is, if the first Q value indicates there is additional Q value and it is carried in DCI/PDCCH, then UE may obtain the second Q in DCI carried in PDCCH of RMSI. If the first Q value indicates there is additional Q value and it is carried in PDSCH of RMSI, then UE may obtain the second Q in RMSI PDSCH.

UE may make assumption on which SSBs are QCLed based on Q value obtained in PBCH or RMSI. Once Q is obtained, UE may determine SSB index based on Q and candidate SSB index.

subCarrierSpacingCommon may be used for indicating the second Q value. An example mapping of the subCarrierSpacingCommon to N_{SSB}^{QCL} is shown in Table 6 of the Appendix. In this case, the scs15or60 and scs30or120 may indicate two Q values for the first Q which in turn may indicate where to look for the second Q, that is, either via DCI/PDCCH or PDSCH of RMSI to obtain the second Q.

subCarrierSpacingCommon and Spare Bit may be used for indicating the first and second Q value. An example mapping between the combination of subCarrierSpacingCommon and Spare Bit to N_{SSB}^{QCL} is shown in Table 7 of the Appendix. In this case, the scs15or60 and spare bit indicate two Q values for the first Q. The scs30or120 and spare bit indicate where to look for the second Q, either via DCI/PDCCH or PDSCH of RMSI to obtain the second Q.

Yet another solution may use override for Q. UE may decode RMSI. If RMSI indicate the “override,” then UE may use the Q obtained in RMSI instead of Q in PBCH. If RMSI indicate the “non-override,” then UE may use the Q obtained in PBCH and ignore the Q in RMSI. This provides additional and more flexibility for UE to acquire Q of the system. UE may make assumption on which SSBs are QCLed based on Q value obtained in either PBCH or RMSI. Once Q is obtained, UE may determine SSB index based on Q and candidate SSB index.

Yet another solution may consider signalling splitting for Q. Assuming N bits needed for Q indication, and they may be split into PBCH and RMSI such as N1 bits for Q are carried in PBCH and the remaining N-N1 bits for Q may be carried in RMSI, e.g., PDCCH of RMSI.

UE may decode PBCH Payload and may obtain the N1 bits from PBCH. UE may continue to decode RMSI. UE may obtain N-N1 bits from RMSI. By combining N1 bits from PBCH and N-N1 bits from RMSI, UE may obtain the Q value. UE may make assumption on which SSBs are QCLed based on Q value obtained in combined PBCH and RMSI. Once Q is obtained, UE may determine SSB index based on Q and candidate SSB index.

The control field subCarrierSpacingCommon and control field pdcch-ConfigSIB1 may be used for indicating different values of Q. For supporting four values of Q, the following table may be used as shown in Table 8 of the Appendix.Option using control field pdcch-ConfigSIB1 for example MSB of pdcch-ConfigSIB1 may be used as below:

If FR1 unlicensed band: N_{SSB}^{QCL}=Q=[1, 2, 4, 8]. If FR2/FR4 unlicensed band: N_{SSB}^{QCL}=Q=[8, 16, 32, 64] or Q=[16, 32, 48, 64]. We may have common set across FR2 and FR4. We may also have FR-specific value set. For example, FR4 may employ N_{SSB}^{QCL}=Q=[16, 32, 48, 64] and FR2 may employ N_{SSB}^{QCL}=Q=[8, 16, 32, 64] as an example.

The control field subCarrierSpacingCommon, Spare Bit and control field pdcch-ConfigSIB1 may be used for indicating different values of Q. For example, for FR2 the Table 9 of the Appendix may be used for supporting beamforming.

For a uniform signaling design, a common Q table may be used for a group of FRs. For example, a common table may be used for FR4 and FR2. An example common Q table is depicted in Table 9 which may be used for both FR4 and FR2.

For non-uniform design, separate and individual Q tables may be used for each FR. For example, a FR-specific table may be used. Table 10 of the Appendix may be FR4-specific and used for FR4 only and Table 11 of the Appendix may be FR2-specific and used for FR2 only.

The control field ssb-SubcarrierOffset in MIB may be used for indication of maximum number of beams for beamforming. For example, LSB of ssb-SubcarrierOffset may be used for indication of N_{SSB}^{QCL}. This is possible for NR unlicensed operation in FR1 where maximum number of beams is eight. Three bits carried in PBCH DMRS are sufficient for SSB indexing for beamforming operation. However, in FR4 and/or FR2, maximum number of beams to be supported for beamforming is sixty-four. Therefore, the control field ssb-SubcarrierOffset in MIB cannot be used for SSB indexing purpose.

Some bit fields in PBCH may be used and re-purposed for explicit indication and signalling. For example, subCarrierSpacingCommon, Spare bit in MIB, PDCCH-ConfigSIB1 (8 bits), LSB of ssb-SubcarrierOffset (4 bits), etc may be utilized. Use of PDCCH-ConfigSIB1 may need to reduce number of RB offsets, number of CORESET symbols, etc. ssb-SubcarrierOffset such as LSB of ssb-SubcarrierOffset cannot be used in FR4 or FR2 in case of 64 beams.

Uniform or non-uniform designs and solutions may be considered. For example, for uniform design: a common configuration table may be used for both FR4 and FR2. For non-uniform design, FR-specific table may be used. UE may be pre-determined or configured with multiple Q tables e.g., Table x for FR2 and Table y for FR4 and no indication for which table to use. Alternatively, UE may be configured with M=2 or more tables and be indicated which configuration table to use in both FR2 and FR4. Combination of implicit and explicit indication for Q may be used. Large Q with indication of the actual candidate SSB position with smaller number of beams for beamforming may be used.

Trade-off between maximum number of beams Q and transmission opportunity for SSB may be performed. Finer granularity for Q with a set of small range of Q values or coarse granularity for Q with a set of large range (or full range) of Q values may be used. Table or Configuration to use may be determined by or based on channel conditions e.g., channel occupancy, LBT failure, traffic load, channel busy ratio, etc. For low channel busy ratio, may use large Q and small TxOP, otherwise for high channel busy ratio, may use small Q and large TxOP, and the like. A UE may assume that SS/PBCH blocks that are within a same or across discovery burst transmission windows are QCLed if (ι̅ mod Q) is the same among the SS/PBCH blocks where ι̅ is the candidate SS/PBCH block index.

It alternative exemplary embodiments, all the exemplary tables defined herein that illustrates mapping between combination of subcarrier spacing and spare bit to N_{SSB}^{QCL} can also be define for combinations of subcarrier spacing, sub-frequency band in a frequency band, and spare bit to N_{SSB}^{QCL}.

### Candidate SSB Positions, Mechanism and Procedures

In this section, candidate SSB mechanisms and acquisition methods are described. Candidate SSB indexing mechanism that supports beamforming for NR unlicensed spectrum supporting up to 71 GHz are described and described. Mechanisms and methods for candidate SSB that overcome or mitigate the channel uncertainty and LBT failure are described. Methods of candidate SSB indexing for different frequency ranges are described and described. The associated indication schemes as well as acquisition procedures for candidate SSB indices are also described. Detailed solutions are described.

Regarding number of candidate SSB positions, we may design candidate SSB positions using a scaling factor. The scaling factor may be applied to maximum number of beams for beamforming. The number of candidate SSB positions may be equal to the Qmax multiplying with such scaling factor. Qmax is 64 in FR4 and FR2. If scaling factor is two, the number of candidate SSB positions may equal to 2X Qmax for beamforming, e.g., 128. If scaling factor is three, the number of candidate SSB positions may equal to 3X the maximum number of beams for beamforming, e.g., 192, and so on.

For example, we may have large candidate SSB positions. We can have 128 candidate SSB positions. This create at least two transmission opportunities or more. For Q=64, this creates two transmission opportunities. For Q<64, this creates more than two transmission opportunities. For Q=1, this creates 128 transmission opportunities. This design could mitigate the channel uncertainty due to LBT. Such design uses a scaling factor of two.

For another example, we may have larger number of candidate SSB positions. e.g., to have 160 candidate SSB positions. This create two transmission opportunities or more. For Q=64, this creates more than two transmission opportunities for some SSBs. For Q<64, this creates much more than two transmission opportunities. For Q=1, this creates 160 transmission opportunities. This design could mitigate more the channel uncertainty due to LBT. However, it will require more bits to indicate candidate SSB positions. One extra bit is required and 3 bits in total as compared to the option with 128 candidate SSB positions which only requires 2 bits for candidate SSB position indexing. Such design employ scaling factor of 2.5.

We may also have larger number of candidate SSB positions. e.g., to have 80, 256, 320 candidate SSB positions or the like. Maximum number of candidate SSB positions may be determined based on subcarrier spacing (SCS) and may be a function of SCS.

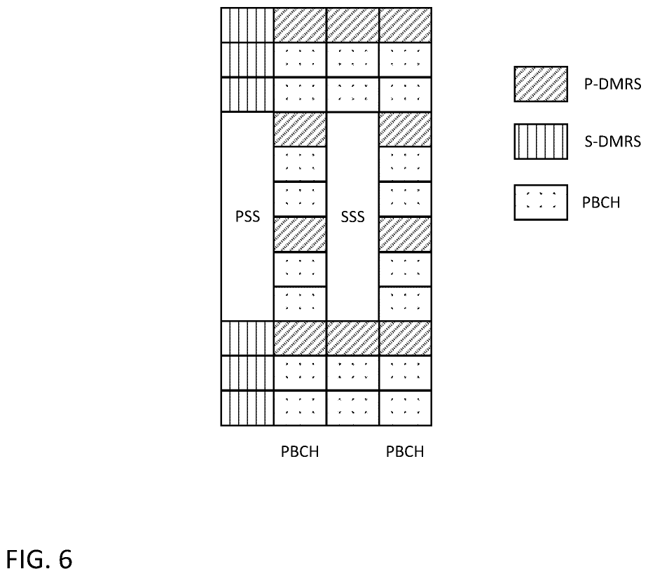

Implicit indication may be considered and used. One solution may use primary DMRS (P-DMRS) and secondary DMRS (S-DMRS) indication. P-DMRS/S-DMRS structure scheme is depicted in FIG. 6. In this scheme, there may be primary DMRS (P-DMRS) residing in the 2^{nd}, 3^{rd}, and 4^{th} OFDM symbols and secondary DMRS (S-DMRS) which resides in the first OFDM symbol in each SSB as shown in FIG. 6. P-DMRS may be used for both channel estimation and SSB indexing. S-DMRS may be used mainly for SSB indexing. P-DMRS may carry 3 bits for SSB index, the same as in Rel-15. S-DMRS may be in the same OFDM symbol as PSS as an example and may carry additional 1 or 2 bits for SSB indexing. Alternatively, S-DMRS may be in different OFDM symbol(s) as PSS. There may be guard band, e.g., a few subcarriers at the border of PSS and SSS in frequency domain which are not shown in the figures.

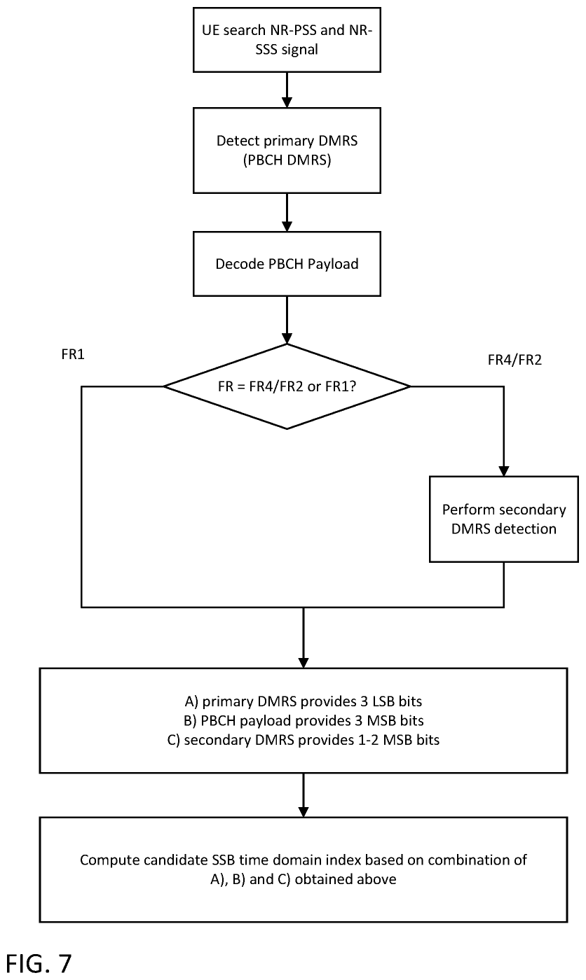

Procedures for P-DMRS/S-DMRS indication scheme is depicted in FIG. 7. UE may search NR-PSS and NR-SSS signal. UE may detect primary DMRS (e.g., PBCH DMRS). UE may decode PBCH Payload. UE may check the frequency range (FR) that it operates. Whether FR=FR4 or FR2 or FR1? If it is FR1, then UE may skip secondary DMRS or S-DMRS detection. If it is FR4 or FR2, then UE may perform secondary DMRS or S-DMRS detection.

Once UE obtain indication bits from P-DMRS, S-DMRS and PBCH payload, UE may determine the final SSB index based on one of the following options for LSB and MSB. There are two options:

In the first option, primary DMRS or P-DMRS may provide 3 LSB bits. Secondary DMRS or S-DMRS may provide additional 1-2 LSB bits. PBCH payload may provide 3 MSB bits.

In the second option, DMRS or P-DMRS may provide 3 LSB bits. PBCH payload may provide 3 MSB bits. Secondary DMRS or S-DMRS may provide 1-2 MSB bits. In FIG. 7 the second option is depicted. UE may compute the candidate SSB index based on the SSB index bits obtained above.

Example mapping between the combination of Primary DMRS (P-DMRS) Index, SSB Index and Secondary DMRS (S-DMRS) Index to Candidate SSB Index is depicted in Table 12 of the Appendix which supports 160 candidate SSB positions. Another example mapping between the combination of Primary DMRS (P-DMRS) Index, SSB Index and Secondary DMRS (S-DMRS) Index to Candidate SSB Index to Candidate SSB Index is depicted in Table 13 of the Appendix which supports 128 candidate SSB positions.

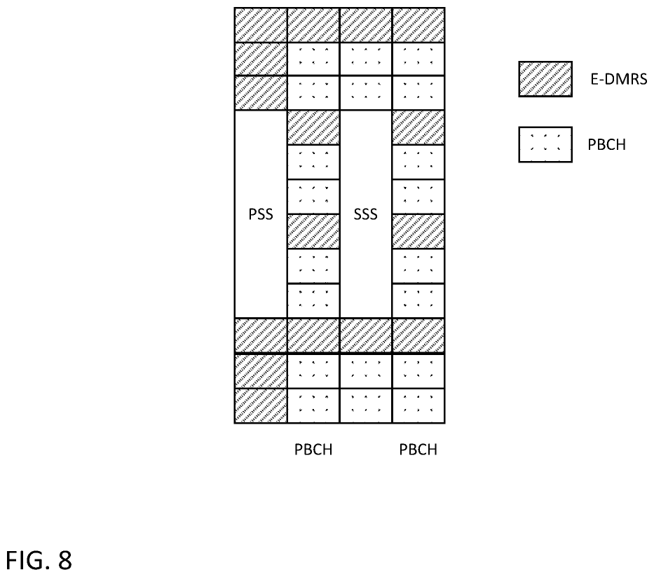

Another solution may use extended DMRS (E-DMRS) for indication. E-DMRS structure scheme is depicted in FIG. 8. In this scheme, DMRS may be extended as shown in FIG. 8 in which additional DMRS may be attached to PSS in frequency domain for extension of existing DMRS. Because of such extension, DMRS length may be increased and more DMRS sequences may be supported simultaneously. For example, E-DMRS may carry 4 or 5 bits for SSB indexing due to the extension. Together with 3 bits in PBCH payload, E-DMRS scheme may have 7 or 8 bits in total which may indicate 128 or 256 candidate SSB positions. In addition, E-DMRS may also be used to assist channel estimation for PBCH detection and decoding.

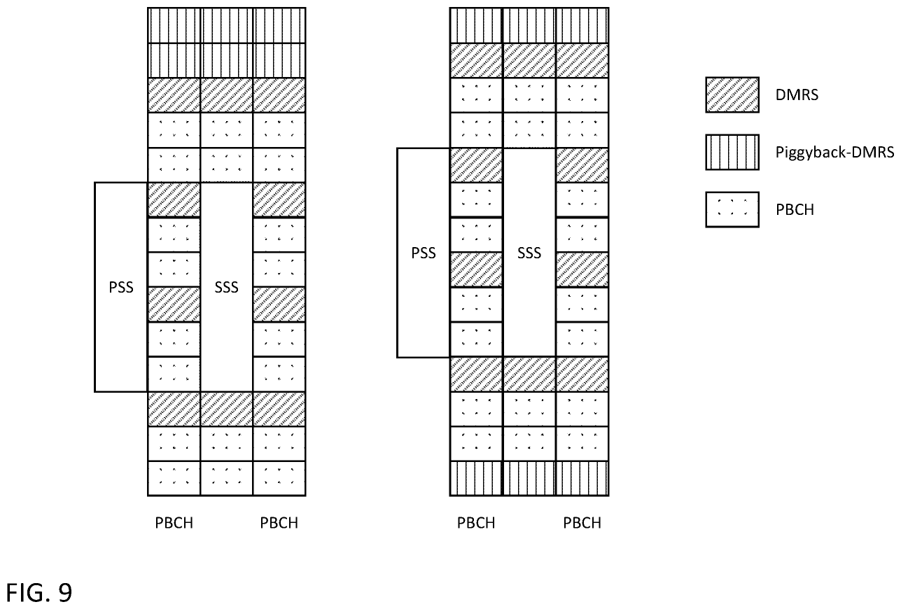

Another solution may use piggyback-DMRS which may be used for indication. Piggyback-DMRS scheme is depicted in FIG. 9. Additional DMRS may be piggybacked on SSB. The left block diagram in FIG. 9 illustrates an asymmetric or non-symmetric piggyback to SSB in frequency domain. The right block diagram in FIG. 9 illustrates a symmetric piggyback to SSB in frequency domain.

If piggyback-DMRS is used for DMRS extension, we may need additional 8 or 24 DMRS e.g., using E-DMRS to extend to 16 or 32 DMRS sequences in total to provide 4 to 5 bits. If DMRS is used for additional indexing purpose similar to S-DMRS, we may need additional 2 or 4 DMRS sequences to provide 1 or 2 bits and thus provide 4 to 5 bits in total for SSB index. 4 to 5 bits together with 3 bits provided by PBCH payload, this could provide up to 128 or 256 candidate SSB indices using piggyback-DMRS.

The cyclic shifts and/or different initialization of sequence for DMRS may be used to carry more information the candidate SSB index in the sequence. The cyclic shifts and/or generation of the DMRS initialization sequence may be a function of the candidate SSB index.

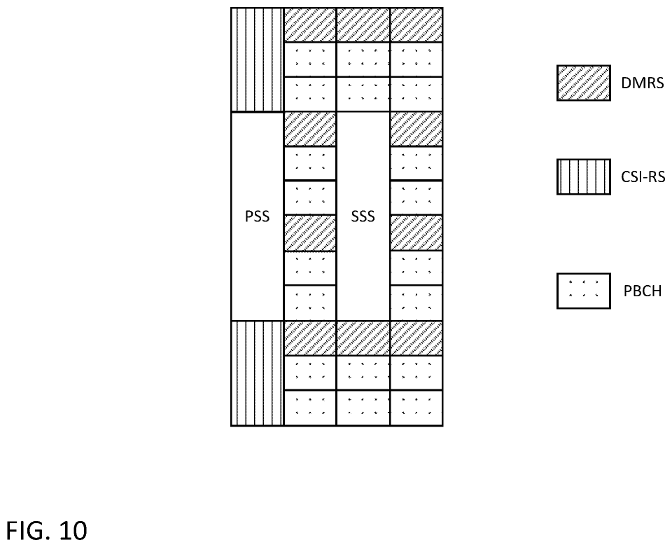

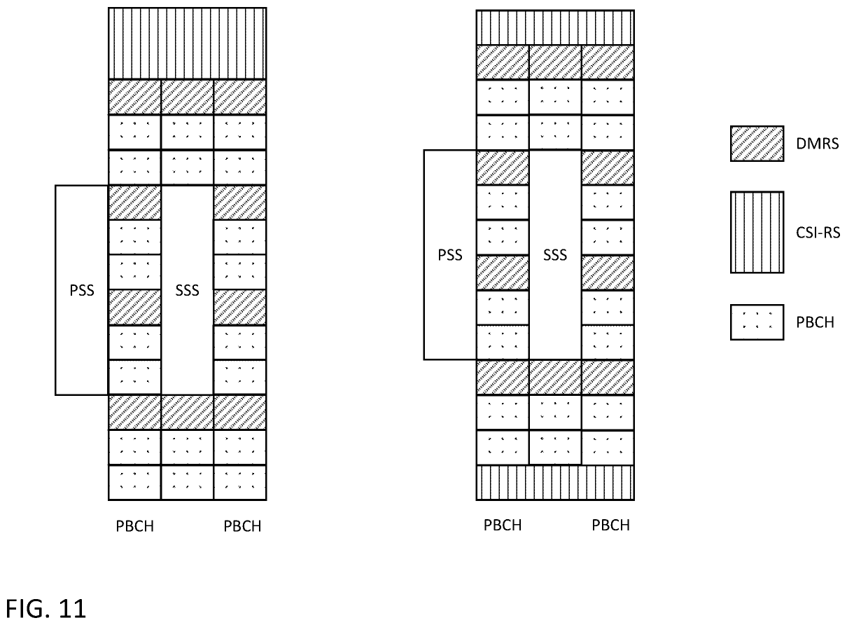

Yet another solution may use joint CSI-RS and DMRS indication. Joint CSI-RS/DMRS (J-CSI-RS/DMRS) structure indication scheme is depicted in FIG. 10. Another example for J-CSI-RS/DMRS structure indication scheme is depicted in FIG. 11. DMRS may be placed inside PBCH in an interleaved manner same as Rel-15. CSI-RS may be multiplexed with SSB and location of CSI-RS may be configured or predefined which may be with respect to SSB location in time and frequency. For example, CSI-RS may be placed adjacent to PSS in frequency domain inside SSB or may be placed adjacent to PBCH outside SSB. CSI-RS adjacent to SSB or PBCH may also be either symmetric or asymmetric. DMRS may carry K1 bits for SSB indexing. CSI-RS may carry K2 bits for SSB indexing. For example, K1 may be 3 bits and K2 may be 1 or 2 bits. Jointly, CSI-RS and DMRS may carry K bits where K=K1+K2 bits.

Alternatively, PBCH may be extended to the first OFDM symbol carrying PSS and be attached to PSS, in the same way as in the third OFDM symbol carrying SSS.

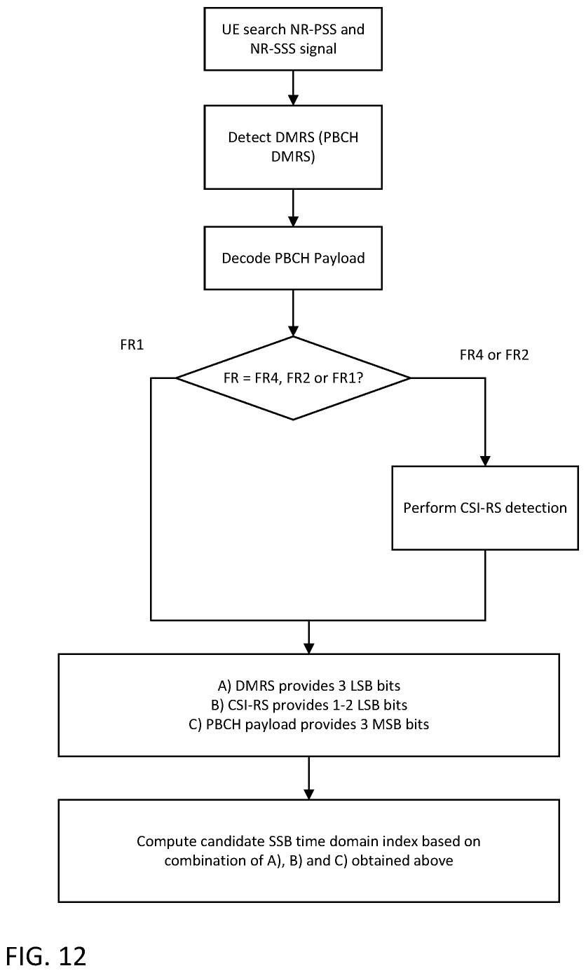

Procedures for Joint CSI-RS/DMRS Scheme is depicted in FIG. 12. UE may search NR-PSS and NR-SSS signals. UE may detect DMRS (e.g., PBCH DMRS). UE may decode PBCH Payload. UE may check the frequency range (FR) that it operates and see whether FR=FR4, FR2 or FR1? If it is FR1, then UE may skip CSI-RS detection. If it is FR4 or FR2, then UE may perform CSI-RS detection. Once UE obtain indication bits from DMRS, CSI-RS and PBCH payload, UE may determine the final SSB index.

There are two options. First, DMRS may provide 3 LSB bits. CSI-RS may provide 1-2 LSB bits and PBCH payload may provide 3 MSB bits. Second, DMRS may provide 3 LSB bits, PBCH payload may provide 3 MSB bits, and CSI-RS may provide additional 1 to 2 MSB bits.

In FIG. 12, the first option depicted. UE may compute the candidate SSB index based on combination of bits obtained above.

An example mapping between the combination of CSI-RS index signal, SSB Index and DMRS to Candidate SSB Index is depicted in Table 14 of the Appendix.

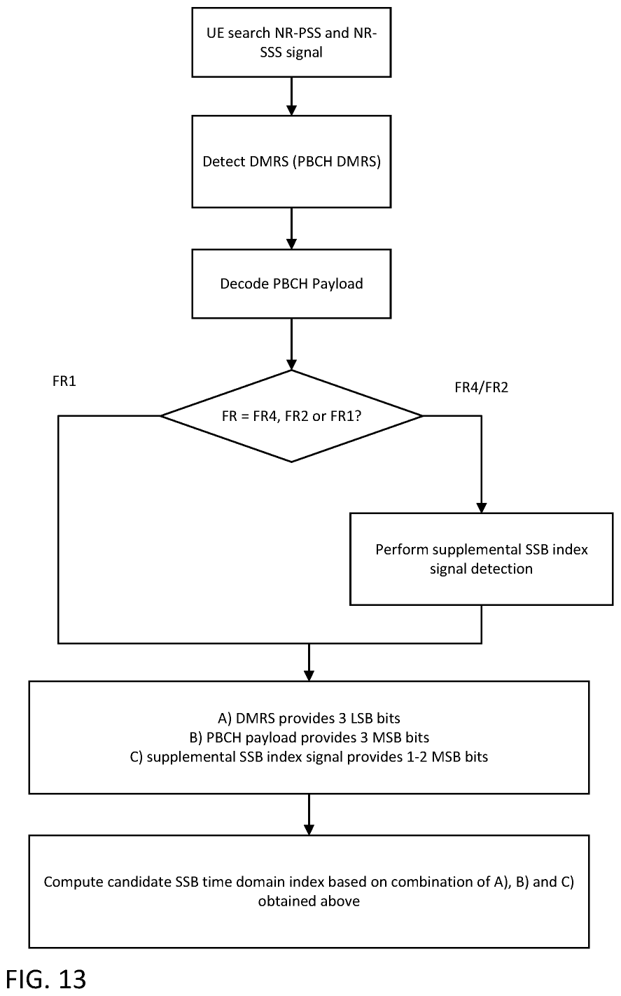

Yet another solution may use supplemental SSB index signal. Method and procedure for supplemental SSB index signal Scheme is depicted in FIG. 13. UE may search NR-PSS and NR-SSS signals. UE may detect DMRS (e.g., PBCH DMRS). UE may decode PBCH Payload. UE may check the frequency range (FR) that it operates. Whether FR=FR4, FR2 or FR1? If it is FR1, then UE may skip supplemental SSB index signal detection. If it is FR4 or FR2, then UE may perform supplemental SSB index signal detection. Once UE obtains indication from DMRS, supplemental SSB index signal and PBCH payload, UE may determine the final SSB index accordingly.

Supplemental SSB index signal may be sequence-based or payload-based based on the design. If supplemental SSB index signal is sequence-based, then signal detection using e.g., correlation may be employed. If supplemental SSB index signal is payload-based and coded using block code, Polar code, or Reed-Muller code etc., then the corresponding channel decoding may be used at the UE.

An example mapping between the combination of Supplemental SSB index signal, SSB Index and DMRS to Candidate SSB Index is depicted in Table 15 of the Appendix. Another example mapping between the combination of Supplemental SSB index signal, SSB Index and DMRS to Candidate SSB Index is depicted in Table 16 of the Appendix.

The number of cell IDs necessary at FR2/4 may be smaller than in FR1. Hence, one option may be to reduce the PCID space by one bit for unlicensed bands. The saved bit may be used for SSB indexing purpose or configuration purpose as described previously.

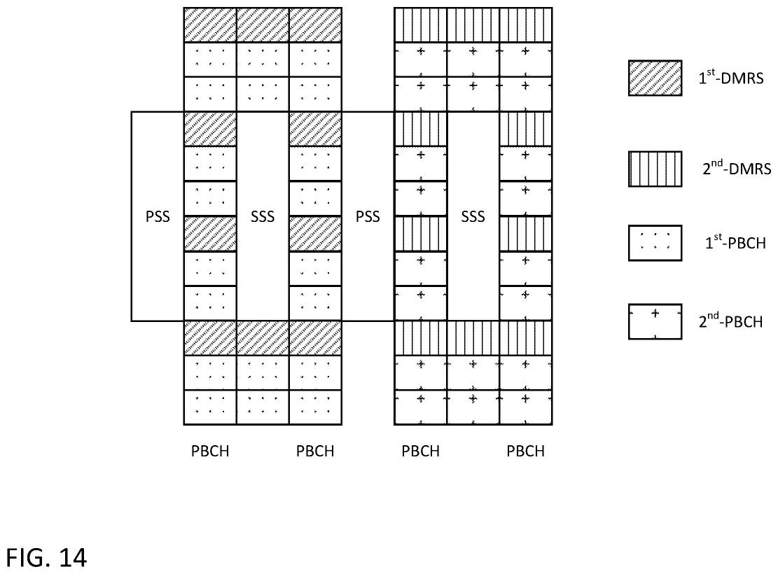

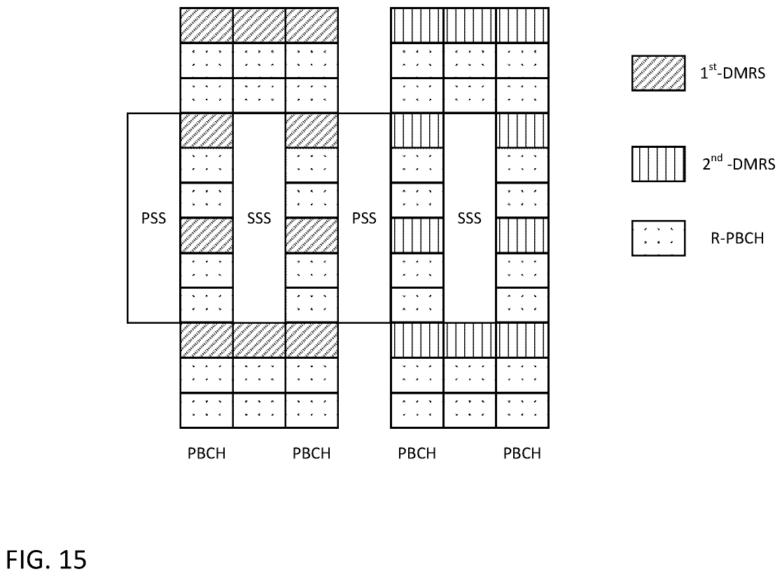

Yet another solution may use group-based SSB (G-SSB). Group-based SSB (G-SSB) structure indication scheme is depicted in FIG. 14 and FIG. 15.

As shown in FIG. 14, the original SSB consists of 4 OFDM symbols. The repeated SSB may consist of 8 OFDM symbols. The second SSB is repeated version of the first SSB. The first and second SSB comprises the group SSB (G-SSB). SSB indexing is performed using G-SSB instead of individual SSB. Each G-SSB may be used to transmit one beam. G-SSB indexing may range from 0 to 159 to support 160 candidate SSB positions. The DMRS of the first SSB inside the G-SSB may provide 3 bits for SSB indexing. The DMRS of the second SSB inside the G-SSB may provide additional 3 bits independently for SSB indexing. With two DMRSs in two SSBs of each G-SSB, each G-SSB can provide up to 6 bits for SSB indexing.

If the second PBCH of G-SSB is a non-repeated version of the first PBCH of G-SSB, then together with the first PBCH payload which can provide 3 bits and the second PBCH payload which can provide additional 3 bits. This scheme can provide up to 12 bits for SSB indexing which is sufficiently enough for supporting 160 candidate G-SSB positions. In this case, the PBCH of the second SSB is a non-repeated version of PBCH of the first SSB in a G-SSB. This is depicted in FIG. 14.

If the second PBCH of G-SSB is repeated version of the first PBCH of G-SSB, then together with PBCH payload which can provide 3 bits. This scheme can provide up to 9 bits for SSB indexing which is sufficient for supporting 160 candidate G-SSB positions. In this case the PBCH of the second SSB is a fully repeated version of PBCH of the first SSB in a G-SSB. This is depicted in FIG. 15.

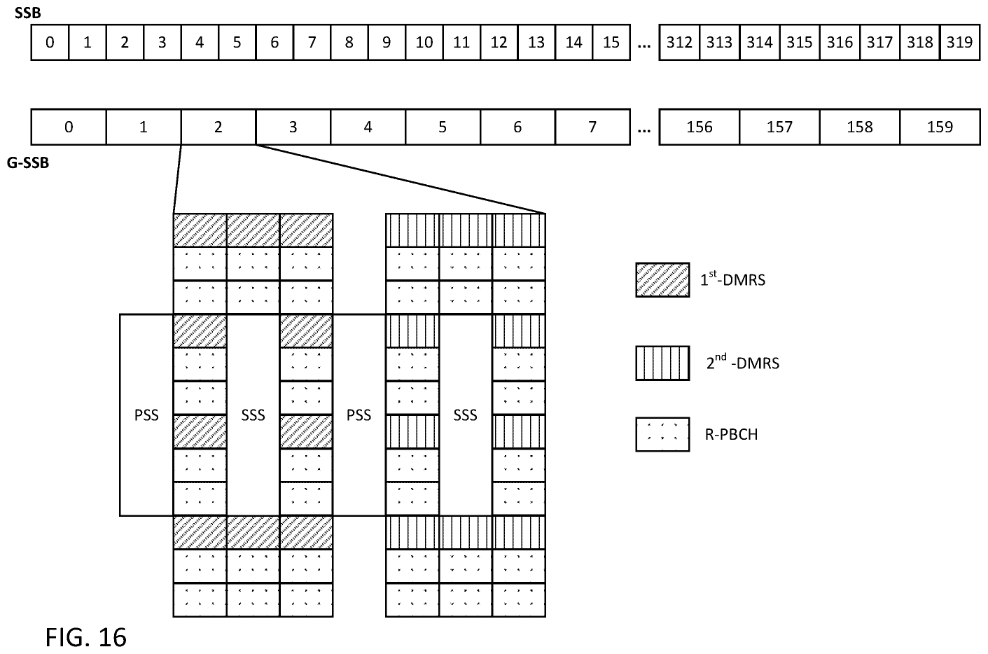

Group-based SSB (G-SSB) indication Scheme is further illustrated in FIG. 16.

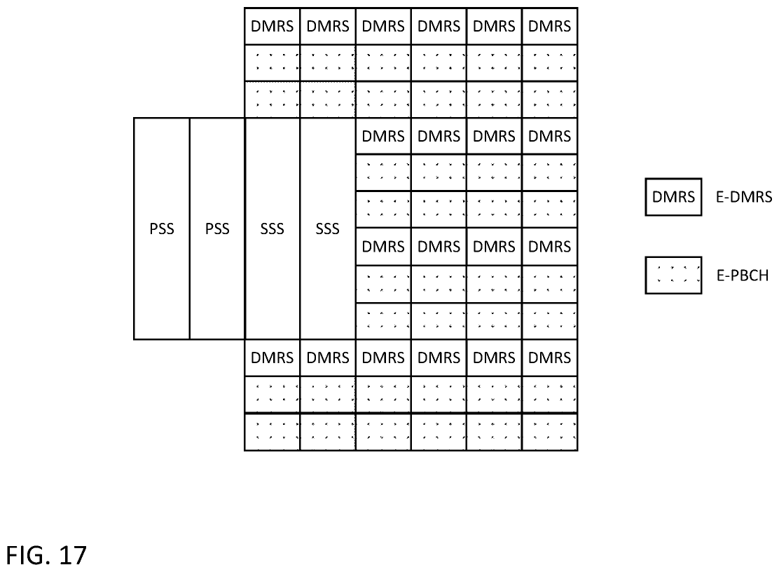

Yet another solution may use extended SSB (E-SSB) indication. An example for extended SSB (E-SSB) structure indication scheme is depicted in FIG. 17. E-SSB structure may comprise multiple PSSs and SSSs (e.g., two PSSs and two SSSs) which may be used for mitigation of frequency offset and phase noise in high frequency range e.g., FR4.

Group-based SSB indication or Extended SSB indication may use joint implicit and explicit indication. Two SSBs in one extended SSB (E-SSB) or group SSB (G-SSB) may consist of two R-SSB (one original and one repeated) or two independent SSB. G-SSB or E-SSB may be used for candidate SSB indexing. G-SSB may not change SSB structure while E-SSB may change SSB structure in terms of PBCH, PSS and/or SSS locations and patterns within the E-SSB.

All the solutions including methods using CSI-RS and/or DMRS that may be associated with SSB may be used to carry information for the value of Q. For example, the sequence and/or the port of the reference signal (RS) may indicate J bits needed to point to the entry of Q table indicating which Q value is used by the gNB or network. J may be 1 or 2 bits or more.

Yet another solution may use explicit indication such as explicit bits in control field(s). pdcch-ConfigSIB1, SSB Index and DMRS Index may be used for such purpose. Example mapping between the combination of MSB of pdcch-ConfigSIB1, SSB Index and DMRS Index to Candidate SSB Index is depicted in Table 17 of the Appendix. Another example mapping between the combination of MSB of pdcch-ConfigSIB1, SSB Index and DMRS Index to Candidate SSB Index is depicted in Table 18 of the Appendix.

Yet another solution may use hybrid indication. Example mapping between the combination of MSB of pdcch-ConfigSIB1, Supplemental SSB index signal, SSB Index and DMRS Index to Candidate SSB Index is depicted in Table 19 of the Appendix.

### Example Environments

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), and LTE-Advanced standards. 3GPP has begun working on the standardization of next generation cellular technology, called New Radio (NR), which is also referred to as “5G”. 3GPP NR standards development is expected to include the definition of next generation radio access technology (new RAT), which is expected to include the provision of new flexible radio access below 6 GHz, and the provision of new ultra-mobile broadband radio access above 6 GHz. The flexible radio access is expected to consist of a new, non-backwards compatible radio access in new spectrum below 6 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 6 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (e.g., broadband access in dense areas, indoor ultra-high broadband access, broadband access in a crowd, 50+ Mbps everywhere, ultra-low cost broadband access, mobile broadband in vehicles), critical communications, massive machine type communications, network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, and virtual reality to name a few. All of these use cases and others are contemplated herein.

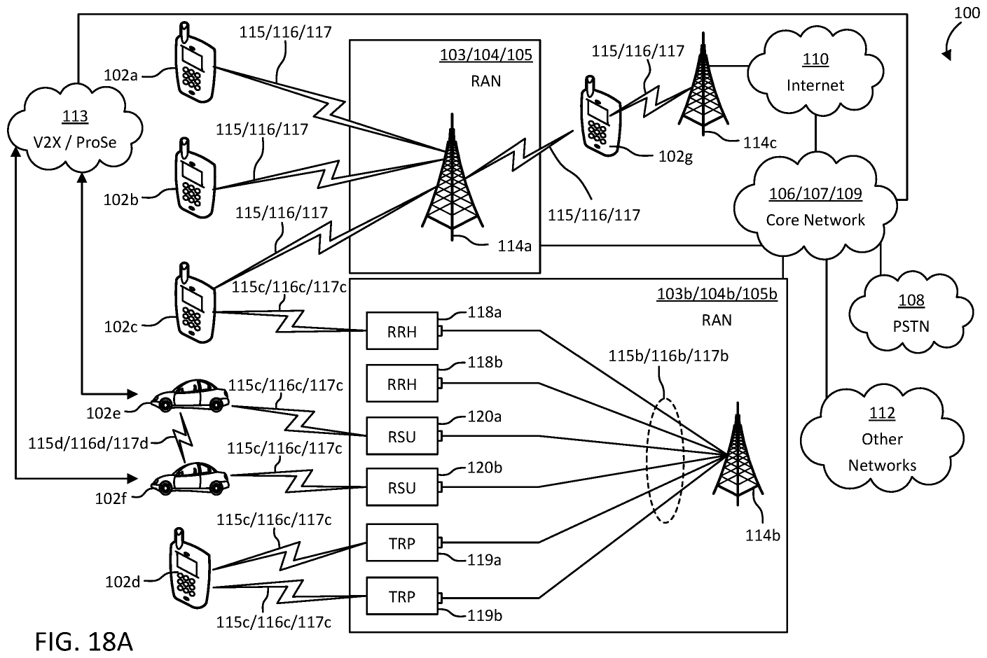

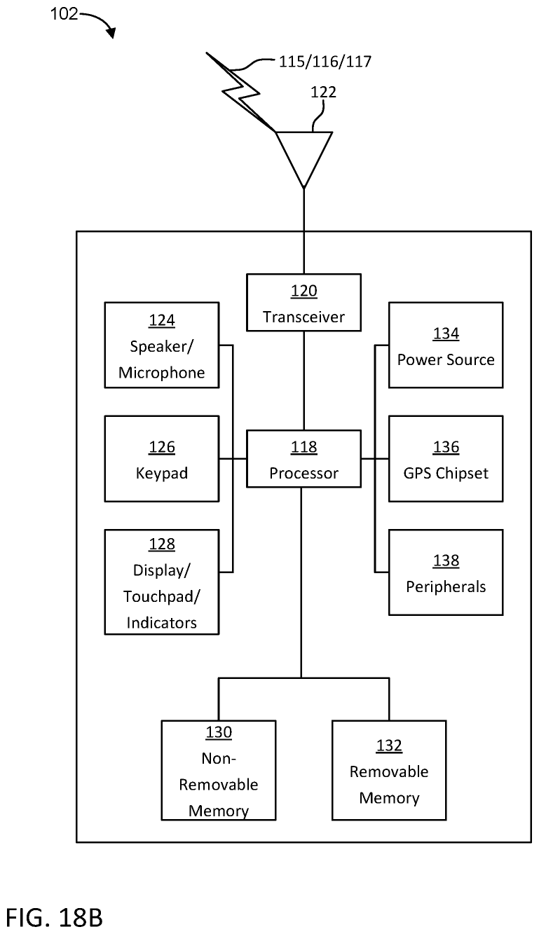

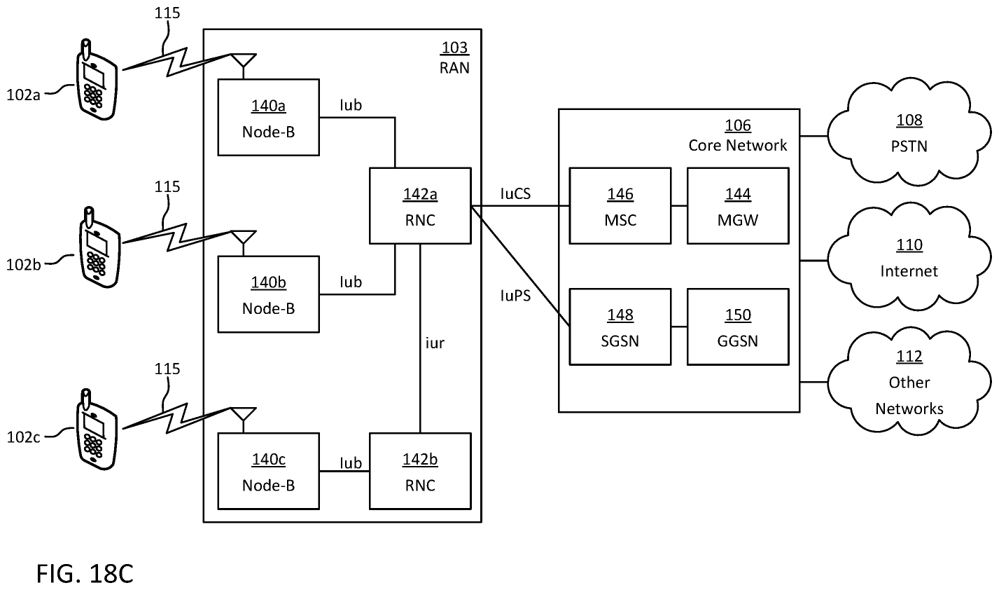

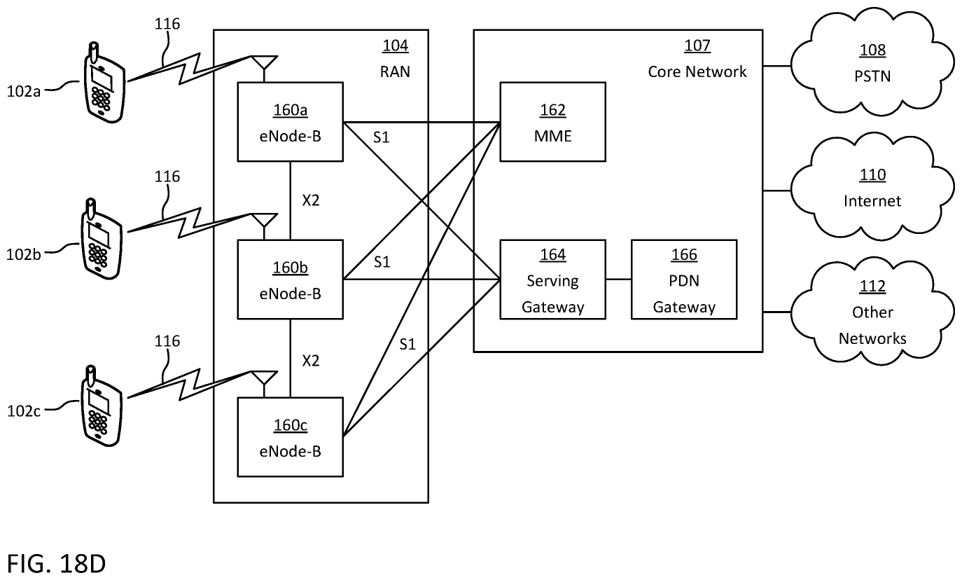

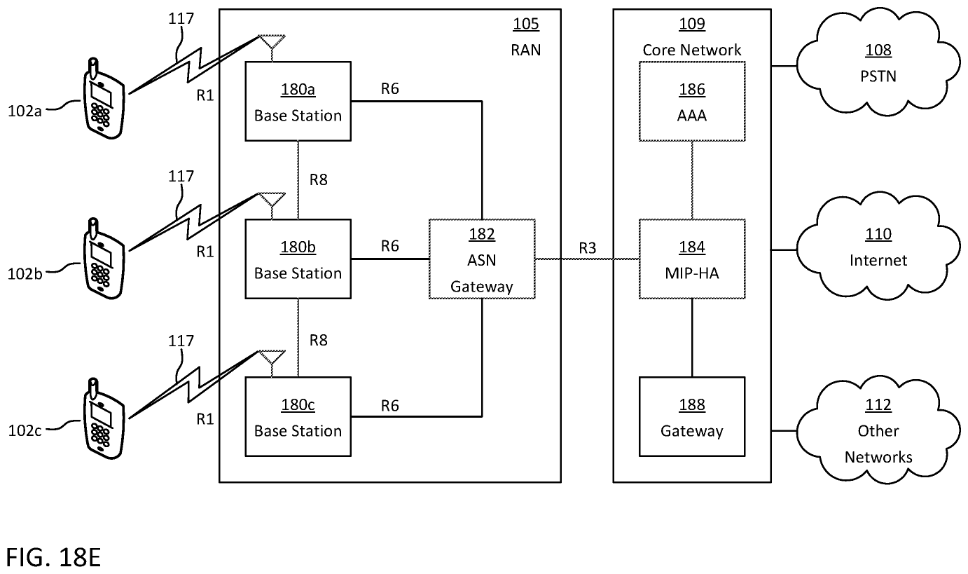

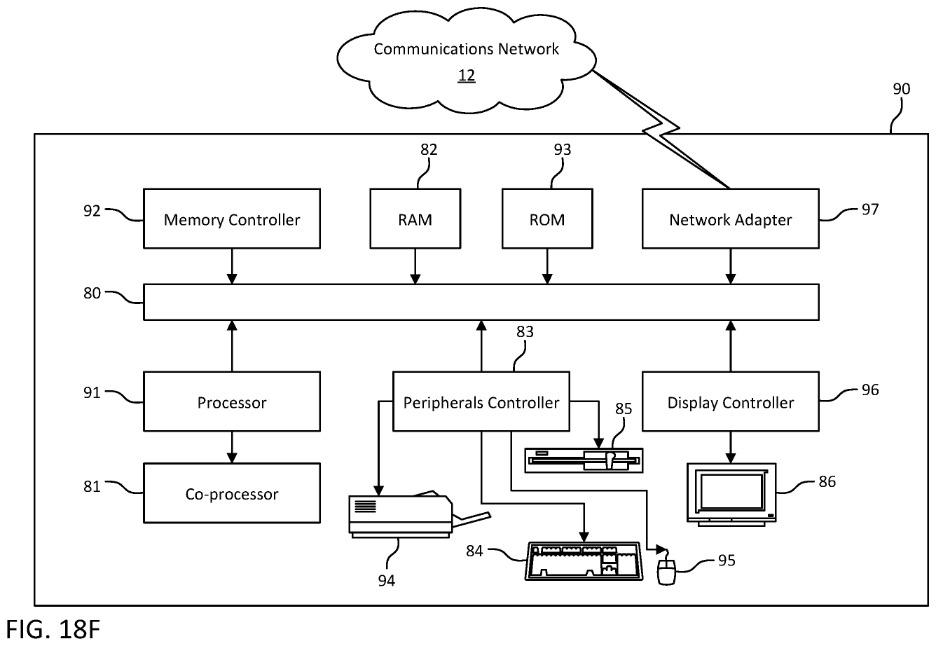

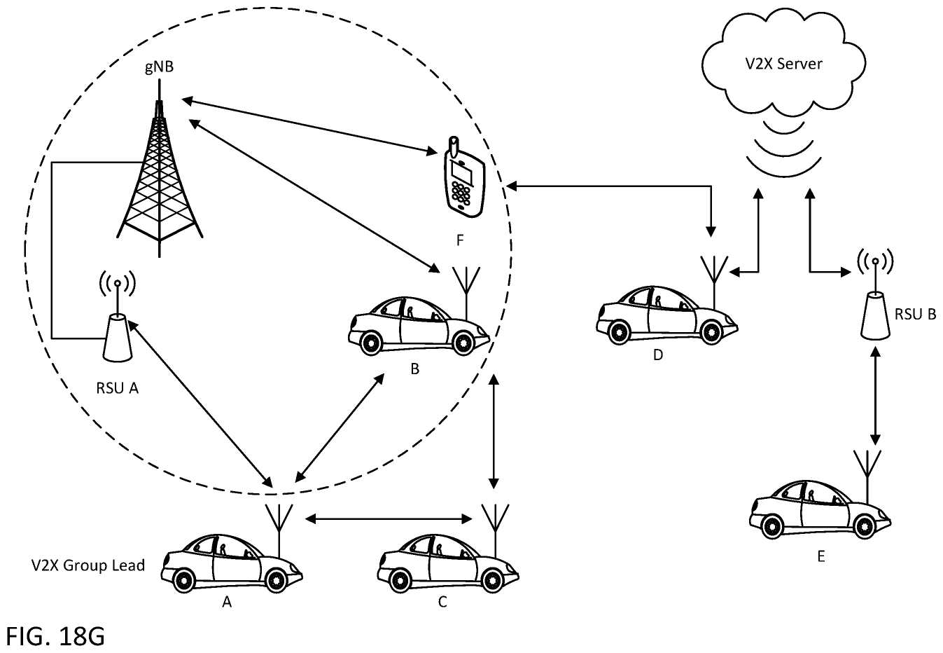

FIG. 18A illustrates one embodiment of an example communications system 100 in which the methods and apparatuses described and claimed herein may be embodied. As shown, the example communications system 100 may include wireless transmit/receive units (WTRUs) 102a, 102b, 102c, 102d, 102e, 102f, and/or 102g (which generally or collectively may be referred to as WTRU 102), a radio access network (RAN) 103/104/105/103b/104b/105b, a core network 106/107/109, a public switched telephone network (PSTN) 108, the Internet 110, other networks 112, and V2X server (or ProSe function and server) 113, though it will be appreciated that the disclosed embodiments contemplate any number of WTRUs, base stations, networks, and/or network elements. Each of the WTRUs 102a, 102b, 102c, 102d, 102e, 102f, 102g may be any type of apparatus or device configured to operate and/or communicate in a wireless environment. Although each WTRU 102a, 102b, 102c, 102d, 102e, 102f, 102g is depicted in FIGS. 18A-18E as a hand-held wireless communications apparatus, it is understood that with the wide variety of use cases contemplated for 5G wireless communications, each WTRU may comprise or be embodied in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, truck, train, or airplane, and the like.

The communications system 100 may also include a base station 114a and a base station 114b. Base stations 114a may be any type of device configured to wirelessly interface with at least one of the WTRUs 102a, 102b, 102c to facilitate access to one or more communication networks, such as the core network 106/107/109, the Internet 110, and/or the other networks 112. Base stations 114b may be any type of device configured to wiredly and/or wirelessly interface with at least one of the RRHs (Remote Radio Heads) 118a, 118b, TRPs (Transmission and Reception Points) 119a, 119b, and/or RSUs (Roadside Units) 120a and 120b to facilitate access to one or more communication networks, such as the core network 106/107/109, the Internet 110, the other networks 112, and/or V2X server (or ProSe function and server) 113. RRHs 118a, 118b may be any type of device configured to wirelessly interface with at least one of the WTRU 102c, to facilitate access to one or more communication networks, such as the core network 106/107/109, the Internet 110, and/or the other networks 112. TRPs 119a, 119b may be any type of device configured to wirelessly interface with at least one of the WTRU 102d, to facilitate access to one or more communication networks, such as the core network 106/107/109, the Internet 110, and/or the other networks 112. RSUs 120a and 120b may be any type of device configured to wirelessly interface with at least one of the WTRU 102e or 102f, to facilitate access to one or more communication networks, such as the core network 106/107/109, the Internet 110, the other networks 112, and/or V2X server (or ProSe function and server) 113. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114b may be part of the RAN 103b/104b/105b, which may also include other base stations and/or network elements (not shown), such as a base station controller (BSC), a radio network controller (RNC), relay nodes, etc. The base station 114a may be configured to transmit and/or receive wireless signals within a particular geographic region, which may be referred to as a cell (not shown). The base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, in an embodiment, the base station 114a may include three transceivers, e.g., one for each sector of the cell. In an embodiment, the base station 114a may employ multiple-input multiple output (MIMO) technology and, therefore, may utilize multiple transceivers for each sector of the cell.

The base stations 114a may communicate with one or more of the WTRUs 102a, 102b, 102c over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b, TRPs 119a, 119b, and/or RSUs 120a and 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

The WTRUs 102a, 102b, 102c,102d, 102e, 102f, and/or 102g may communicate with one another over an air interface 115d/116d/117d (not shown in the figures), which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b,TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c, or RRHs 118a, 118b, TRPs 119a, 119b, and/or RSUs 120a, 120b, in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A). In the future, the air interface 115/116/117 may implement 3GPP NR technology. The LTE and LTE-A technology includes LTE D2D and V2X technologies and interface (such as Sidelink communications, etc.) The 3GPP NR technology includes NR V2X technologies and interface (such as Sidelink communications, etc.)

In an embodiment, the base station 114a in the RAN 103/104/105 and the WTRUs 102a, 102b, 102c, or RRHs 118a, 118b, TRPs 119a, 119b and/or RSUs 120a, 120b, in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 18A may be a wireless router, Home Node B, Home eNode B, or access point, for example, and may utilize any suitable RAT for facilitating wireless connectivity in a localized area, such as a place of business, a home, a vehicle, a campus, and the like. In an embodiment, the base station 114c and the WTRUs 102e, may implement a radio technology such as IEEE 802.11 to establish a wireless local area network (WLAN). In an embodiment, the base station 114c and the WTRUs 102d, may implement a radio technology such as IEEE 802.15 to establish a wireless personal area network (WPAN). In yet another embodiment, the base station 114c and the WTRUs 102e, may utilize a cellular-based RAT (e.g., WCDMA, CDMA2000, GSM, LTE, LTE-A, etc.) to establish a picocell or femtocell. As shown in FIG. 18A, the base station 114b may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication.

Although not shown in FIG. 18A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d, 102e to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 and/or RAN 103b/104b/105b or a different RAT.

Some or all of the WTRUs 102a, 102b, 102c, 102d in the communications system 100 may include multi-mode capabilities, e.g., the WTRUs 102a, 102b, 102c, 102d, and 102e may include multiple transceivers for communicating with different wireless networks over different wireless links. For example, the WTRU 102e shown in FIG. 18A may be configured to communicate with the base station 114a, which may employ a cellular-based radio technology, and with the base station 114c, which may employ an IEEE 802 radio technology.

FIG. 18B is a block diagram of an example apparatus or device configured for wireless communications in accordance with the embodiments illustrated herein, such as for example, a WTRU 102. As shown in FIG. 18B, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 18B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 18B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet an embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 18B as a single element, the WTRU 102 may include any number of transmit/receive elements 122. More specifically, the WTRU 102 may employ MIMO technology. Thus, in an embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit). The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In an embodiment, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The WTRU 102 may connect to other components, modules, or systems of such apparatuses or devices via one or more interconnect interfaces, such as an interconnect interface that may comprise one of the peripherals 138.

FIG. 18C is a system diagram of the RAN 103 and the core network 106 according to an embodiment. As noted above, the RAN 103 may employ a UTRA radio technology to communicate with the WTRUs 102a, 102b, and 102c over the air interface 115. The RAN 103 may also be in communication with the core network 106. As shown in FIG. 18C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 18C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macro-diversity, security functions, data encryption, and the like.

The core network 106 shown in FIG. 18C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 18D is a system diagram of the RAN 104 and the core network 107 according to an embodiment. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 18D, the eNode-Bs 160a, 160b, 160c may communicate with one another over an X2 interface.

The core network 107 shown in FIG. 18D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 18E is a system diagram of the RAN 105 and the core network 109 according to an embodiment. The RAN 105 may be an access service network (ASN) that employs IEEE 802.16 radio technology to communicate with the WTRUs 102a, 102b, and 102c over the air interface 117. As will be further discussed below, the communication links between the different functional entities of the WTRUs 102a, 102b, 102c, the RAN 105, and the core network 109 may be defined as reference points.

As shown in FIG. 18E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell in the RAN 105 and may include one or more transceivers for communicating with the WTRUs 102a, 102b, 102c over the air interface 117. In an embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, and 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, and 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 18E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, and 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 18E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

The core network entities described herein and illustrated in FIGS. 18A, 18C, 18D, and 18E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 18A-18E are provided by way of example only, and it is understood that the subject matter disclosed and claimed herein may be embodied or implemented in any similar communication system, whether presently defined or defined in the future.

FIG. 18F is a block diagram of an exemplary computing system 90 in which one or more apparatuses of the communications networks illustrated in FIGS. 18A, 18C, 18D, and 18E may be embodied, such as certain nodes or functional entities in the RAN 103/104/105, Core Network 106/107/109, PSTN 108, Internet 110, or Other Networks 112. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices.

Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a network adapter 97, that may be used to connect computing system 90 to an external communications network, such as the RAN 103/104/105, Core Network 106/107/109, PSTN 108, Internet 110, or Other Networks 112 of FIGS. 18A-18E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

FIG. 18G illustrates one embodiment of an example communications system 111 in which the methods and apparatuses described and claimed herein may be embodied. As shown, the example communications system 111 may include wireless transmit/receive units (WTRUs) A, B, C, D, E, F, a base station, a V2X server, and a RSUs A and B, though it will be appreciated that the disclosed embodiments contemplate any number of WTRUs, base stations, networks, and/or network elements. One or several or all WTRUs A, B, C, D, E can be out of range of the network. In the example of FIG. 18G, the cell coverage boundary shown as a dashed line. WTRUs A, B, C form a V2X group, among which WTRU A is the group lead and WTRUs B and C are group members. WTRUs A, B, C, D, E, F may communicate over Uu interface or Sidelink (PC5) interface.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations or functions described herein may be implemented in the form of such computer executable instructions, executing on the processor of an apparatus or computing system configured for wireless and/or wired network communications. Computer readable storage media include volatile and nonvolatile, removable, and non-removable media implemented in any non-transitory (e.g., tangible, or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

### APPENDIX

TABLE 1
Example mapping between the combination
of subCarrierSpacingCommon and Spare
Bit to N_{SSB}^{QCL}

| subCarrierSpacingCommon | Spare bit | N_{SSB}^{QCL} |
|---|---|---|
| scs15or60 | 0 | Q0 |
| scs15or60 | 1 | Q1 |
| scs30or120 | 0 | Q2 |
| scs30or120 | 1 | Pointer to RMSI |

TABLE 2
Example mapping between the combination
of subCarrierSpacingCommon and Spare Bit to
N_{SSB}^{QCL} (Coarse granularity)

| subCarrierSpacingCommon | Spare bit | N_{SSB}^{QCL} |
|---|---|---|
| scs15or60 | 0 | 1 |
| scs15or60 | 1 | 8 |
| scs30or120 | 0 | 32 |
| scs30or120 | 1 | 64 |

TABLE 3
Example mapping between the combination
of subCarrierSpacingCommon and Spare Bit to
N_{SSB}^{QCL} (Fine granularity)

| subCarrierSpacingCommon | Spare Bit | N_{SSB}^{QCL} |
|---|---|---|
| scs15or60 | 0 | 16 |
| scs15or60 | 1 | 32 |
| scs30or120 | 0 | 48 |
| scs30or120 | 1 | 64 |

TABLE 4
Example Mapping between the combination
of subCarrierSpacingCommon and Spare Bit to
N_{SSB}^{QCL} (Fine granularity)

| subCarrierSpacingCommon | Spare Bit | N_{SSB}^{QCL} |
|---|---|---|
| scs15or60 | 0 | 8 |
| scs15or60 | 1 | 16 |
| scs30or120 | 0 | 32 |
| scs30or120 | 1 | 64 |

TABLE 5
Example mapping between the combination
of subCarrierSpacingCommon, Spare Bit, and MSB
of pdcch-ConfigSIB1 to N_{SSB}^{QCL}

| | | MSB of pdcch- | |
|---|---|---|---|
| subCarrierSpacingCommon | Spare bit | ConfigSIB1 | N_{SSB}^{QCL} |
| scs15or60 | 0 | 0 | Q0 |
| scs15or60 | 0 | 1 | Q1 |
| scs15or60 | 1 | 0 | Q2 |
| scs15or60 | 1 | 1 | Q3 |
| scs30or120 | 0 | 0 | Q4 |
| scs30or120 | 0 | 1 | Q5 |
| scs30or120 | 1 | 0 | Q6 |
| scs30or120 | 1 | 1 | Q7 |

TABLE 6
Example mapping between the combination
of subCarrierSpacingCommon and Spare
Bit to N_{SSB}^{QCL}

| subCarrierSpacingCommon | N_{SSB}^{QCL} |
|---|---|
| scs15or60 | DCI/PDCCH |
| scs30or120 | PDSCH |

TABLE 7
Example mapping between the combination
of subCarrierSpacingCommon and Spare
Bit to N_{SSB}^{QCL}

| subCarrierSpacingCommon | Spare bit | N_{SSB}^{QCL} |
|---|---|---|
| scs15or60 | 0 | Q0 |
| scs15or60 | 1 | Q1 |
| scs30or120 | 0 | DCI/PDCCH |
| scs30or120 | 1 | PDSCH |

TABLE 8
Example mapping between the combination
of subCarrierSpacingCommon and MSB of pdcch-
ConfigSIB1 to N_{SSB}^{QCL}

| subCarrierSpacingCommon | MSB of pdcch-ConfigSIB1 | N_{SSB}^{QCL} |
|---|---|---|
| scs15or60 | 0 | Q0 |
| scs15or60 | 1 | Q1 |
| scs30or120 | 0 | Q2 |
| scs30or120 | 1 | Q3 |

TABLE 9
Example Uniform design across FR2 and FR4: Mapping
between the combination of subCarrierSpacingCommon and spare
or MSB of pdcch-ConfigSIB1 to N_{SSB}^{QCL}

| | | MSB of pdcch- | |
|---|---|---|---|
| Spare bit | subCarrierSpacingCommon | ConfigSIB1 | N_{SSB}^{QCL} |
| 0 | scs15or60 | 0 | 1 |
| 0 | scs15or60 | 1 | 2 |
| 0 | scs30or120 | 0 | 4 |
| 0 | scs30or120 | 1 | 8 |
| 1 | scs15or60 | 0 | 16 |
| 1 | scs15or60 | 1 | 24 |
| 1 | scs30or120 | 0 | 32 |
| 1 | scs30or120 | 1 | 64 |

TABLE 10
Example Non-uniform design: FR2 Mapping between
the combination of subCarrierSpacingCommon, spare, and
MSB of pdcch-ConfigSIB1 to N_{SSB}^{QCL}

| | | MSB of pdcch- | |
|---|---|---|---|
| Spare bit | subCarrierSpacingCommon | ConfigSIB1 | N_{SSB}^{QCL} |
| 0 | scs15or60 | 0 | 1 |
| 0 | scs15or60 | 1 | 2 |
| 0 | scs30or120 | 0 | 4 |
| 0 | scs30or120 | 1 | 8 |
| 1 | scs15or60 | 0 | 16 |
| 1 | scs15or60 | 1 | 24 |
| 1 | scs30or120 | 0 | 32 |
| 1 | scs30or120 | 1 | 64 |

TABLE 11
Example Non-uniform design: FR4 Mapping between
the combination of subCarrierSpacingCommon, spare, and
MSB of pdcch-ConfigSIB1 to N_{SSB}^{QCL}

| | | MSB of pdcch- | |
|---|---|---|---|
| Spare bit | subCarrierSpacingCommon | ConfigSIB1 | N_{SSB}^{QCL} |
| 0 | scs15or60 | 0 | 16 |
| 0 | scs15or60 | 1 | 20 |
| 0 | scs30or120 | 0 | 24 |
| 0 | scs30or120 | 1 | 28 |
| 1 | scs15or60 | 0 | 32 |
| 1 | scs15or60 | 1 | 36 |
| 1 | scs30or120 | 0 | 48 |
| 1 | scs30or120 | 1 | 64 |

TABLE 12
Example mapping between the combination of
primary DMRS (P-DMRS), SSB Index and secondary
DMRS (S-DMRS) to Candidate SSB Index

| Secondary DMRS | | Primary DMRS | Candidate |
|---|---|---|---|
| (S-DMRS) Index | SSB Index | (P-DMRS) Index | SSB Index |
| 2 bits | 3 bits | 3 bits | 0-159 |

TABLE 13
Example mapping between the combination of Supplemental SSB
index signal, SSB Index, and DMRS to Candidate SSB Index

| Secondary DMRS | | Primary DMRS | Candidate |
|---|---|---|---|
| (S-DMRS) Index | SSB Index | (P-DMRS) Index | SSB Index |
| 1 bit | 3 bits | 3 bits | 0-127 |

TABLE 14
Example mapping between the combination of CSI-RS index
signal, SSB Index and DMRS to Candidate SSB Index

| | | | Candidate |
|---|---|---|---|
| CSI-RS Index | SSB Index | DMRS Index | SSB Index |
| 2 bits | 3 bits | 3 bits | 0-159 |

TABLE 15
Example mapping between the combination of Supplemental SSB
index signal, SSB Index and DMRS to Candidate SSB Index

| Supplemental | | | Candidate |
|---|---|---|---|
| SSB index signal | SSB Index | DMRS Index | SSB Index |
| 2 bits | 3 bits | 3 bits | 0-159 |

TABLE 16
Example mapping between the combination of Supplemental SSB
index signal, SSB Index and DMRS to Candidate SSB Index

| Supplemental | | | Candidate |
|---|---|---|---|
| SSB index signal | SSB Index | DMRS Index | SSB Index |
| 1 bit | 3 bits | 3 bits | 0-127 |

TABLE 17
Example mapping between the combination of MSB of pdcch-
ConfigSIB1, SSB Index and DMRS to Candidate SSB Index

| MSB of pdcch- | | | Candidate |
|---|---|---|---|
| ConfigSIB1 | SSB Index | DMRS Index | SSB Index |
| 1 bit | 3 bits | 3 bits | 0-127 |

TABLE 18
Example mapping between the combination of MSB of pdcch-
ConfigSIB1, SSB Index and DMRS to Candidate SSB Index

| MSB#1 | MSB#0 | | | |
|---|---|---|---|---|
| of pdcch- | of pdcch- | | | Candidate |
| ConfigSIB1 | ConfigSIB1 | SSB Index | DMRS Index | SSB Index |
| 1 bit | 1 bit | 3 bits | 3 bits | 0-159 |

TABLE 19
Example mapping between the combination of MSB of pdcch-
ConfigSIB1, Supplemental SSB index signal, SSB Index
and DMRS to Candidate SSB Index (Hybrid Method)

| MSB#1 | Supplemental | | | |
|---|---|---|---|---|
| of pdcch- | SSB index | | | Candidate |
| ConfigSIB1 | signal | SSB Index | DMRS Index | SSB Index |
| 1 bit | 1 bit | 3 bits | 3 bits | 0-159 |

TABLE 20
Abbreviations and Definitions

| | |
|---|---|
| A/N | Ack/Nack |
| BRS | Beam Reference Signal |
| BWP | Bandwidth Part |
| CA | Carrier aggregation |
| CBR | Channel Busy Ratio |
| CBW | Channel Bandwidth |
| CCA | Clear channel assessment |
| CE | Control Element |
| COT | Channel Occupation Time |
| CRB | Carrier Resource Block |
| DL | Downlink |
| DMRS | DeModulation Reference Signal |
| DRS | Discovery Reference Signal |
| DRX | Discontinuous Reception |
| eMBB | enhanced Mobile Broadband |
| FR1 | Frequency Range 1 |
| FR2 | Frequency Range 2 |
| FR4 | Frequency Range 4 |
| GNSS | Global Navigation Satellite System |
| HARQ | Hybrid Automatic Repeat Request |
| IEEE | Institute of Electrical and Electronics Engineers |
| LAA | Licensed-assisted access |
| LBT | Listen Before Talk |
| LTE | Long term Evolution |
| MAC | Medium Access Control |
| MIB | Master Information Block |
| mMTC | massive Machine Type Communication |
| NACK | Non-ACKnowledgement |
| NR | New Radio |
| NR-U | New Radio Unlicensed |
| PBCH | Physical Broadcast Channel |
| PDCCH | Physical Downlink Control Channel |
| PDSCH | Physical Downlink Shared Data Channel |
| PRACH | Physical Random-Access Channel |
| PRB | Physical Resource Block |
| PSDCH | Physical Sidelink Discovery Channel |
| PSFCH | Physical Sidelink Feedback Channel |
| PSS | Primary Synchronization Signal |
| PT-RS | Phase Tracking Reference Signal |
| RAN | Radio Access Network |
| RAT | Radio Access Technology |
| RMSI | Remaining Minimum System Information |
| RNTI | Radio Network Temporary Identifier |
| RSTD | Reference Signal Timing Difference |
| RRC | Radio Resource Control |
| SCI | Sidelink Control Information |
| SI | System Information |
| SIB | System Information Block |
| SRS | Sounding Reference Signal |
| SS | Synchronization Signal |
| SSB | Synchronization Signal Block |
| SSS | Secondary Synchronization Signal |
| TCI | Transmission Configuration Index |
| TDD | Time Division Duplex |
| UE | User Equipment |
| UL | Uplink |
| URLLC | Ultra-Reliable and Low Latency Communications |

1-20. (canceled)

21. A wireless transmit/receive unit (WTRU) comprising a processor and memory storing instructions which, when executed by the processor, cause the WTRU to:
selecting a fine granularity configuration table from a plurality of configuration tables, wherein each of the plurality of configuration tables are indicative of a plurality of beam (Q) values for beamforming;
detect a primary synchronization signal (PSS) and a secondary synchronization signal (SSS);
decode, from the detected PSS and the detected SSS, a physical broadcast channel (PBCH) payload;
identify, based on the PBCH payload and the fine granularity configuration table, a Q value indicative of a maximum number of beams for beamforming, wherein the fine granularity configuration table comprises a subset of Q values of a range of Q values for beamforming;
determine, based on the maximum number of beams indicated by one of the plurality of Q values and a candidate synchronization signal block (SSB) index, an SSB time domain index; and
determine, based on the determined SSB time domain index and the maximum number of beams indicated by the identified Q value, one or more quasi co-located (QCL) SSBs.

22. The WTRU of claim 21, wherein the identified Q value is indicative of the maximum number of beams for beamforming in shared spectrum.

23. The WTRU of claim 21, wherein the fine granularity configuration table comprises a mapping between each Q value of the subset of Q values and a respective value for an information field of a master information block (MIB).

24. The WTRU of claim 23, wherein the information field comprises a subCarrierSpacingCommon field, and the respective value comprises a subcarrier spacing value.

25. The WTRU of claim 21, wherein the plurality of configuration tables further comprises a course granularity table.

26. New) The WTRU of claim 21, wherein:
the PBCH payload points to Remaining Minimum System Information (RMSI); and
the instructions further cause the WTRU to decode the RMSI to obtain the maximum number of beams.

27. The WTRU of claim 21, wherein the instructions, when executed by the processor, further cause the WTRU to:
detect a synchronization signal (SS);
decode the SS; and
determine, from the decoded SS, an indication for selecting the fine granularity configuration table, wherein the selecting the fine granularity configuration table is according to the indication.

28. The WTRU of claim 21, wherein the subset of Q values comprises two Q values.

29. The WTRU of claim 21, wherein the instructions further cause the WTRU to decode a Physical Downlink Control Channel (PDCCH) or a Physical Downlink Shared Data Channel (PDSCH) of a Remaining Minimum System Information (RMSI) to obtain the maximum number of beams.

30. A method by a wireless transmit/receive unit (WTRU) comprising:
selecting a fine granularity configuration table from a plurality of configuration tables, wherein each of the plurality of configuration tables are indicative of a plurality of beam (Q) values for beamforming;
detecting a primary synchronization signal (PSS) and a secondary synchronization signal (SSS);
decoding, from the detected PSS and the detected SSS, a physical broadcast channel (PBCH) payload;
identifying, based on the PBCH payload and the fine granularity configuration table, a Q value indicative of a maximum number of beams for beamforming, wherein the fine granularity configuration table comprises a subset of Q values of a range of Q values for beamforming;
determining, based on the maximum number of beams indicated by one of the plurality of Q values and a candidate synchronization signal block (SSB) index, an SSB time domain index; and
determining, based on the determined SSB time domain index and the maximum number of beams indicated by the identified Q value, one or more quasi co-located (QCL) SSBs.

31. The method of claim 30, wherein the identified Q value is indicative of the maximum number of beams for beamforming in shared spectrum.

32. The method of claim 30, wherein the fine granularity configuration table comprises a mapping between each Q value of the subset of Q values and a respective value for an information field of a master information block (MIB).

33. The method of claim 32, wherein the information field comprises a subCarrierSpacingCommon field, and the respective value comprises a subcarrier spacing value.

34. The method of claim 30, wherein the plurality of configuration tables further comprises a course granularity table.

35. The method of claim 30, wherein:
the PBCH payload points to Remaining Minimum System Information (RMSI); and
the instructions further cause the WTRU to decode the RMSI to obtain the maximum number of beams.

36. The method of claim 30, further comprising:
detecting a synchronization signal (SS);
decoding the SS; and
determining, from the decoded SS, an indication for selecting the fine granularity table, wherein the selecting the fine granularity table is according to the indication.

37. The method of claim 30, wherein the subset of Q values comprises two Q values.

38. The method of claim 30, further comprising:
decoding a Physical Downlink Control Channel (PDCCH) or a Physical Downlink Shared Data Channel (PDSCH) of a Remaining Minimum System Information (RMSI) to obtain the maximum number of beams.
